(19) United States
(12) Patent Application Publication
(10) Pub. No.: US 2026/0020069 A1
(43) Pub. Date: Jan. 15, 2026

(54) CONTROLLING PHYSICAL RANDOM ACCESS CHANNEL (PRACH) TRANSMISSION POWER

(71) Applicant: SHARP KABUSHIKI KAISHA, Osaka (JP)

(72) Inventors: Tomoki Yoshimura, Camas, WA (US); Zhanping Yin, Vancouver, WA (US)

(21) Appl. No.: 18/768,519

(22) Filed: Jul. 10, 2024

(51) Int. Cl. H04W 74/0833; H04L 5/14; H04W 52/50

(52) U.S. Cl. CPC H04W 74/0833; H04L 5/14; H04W 52/50

(57) ABSTRACT

A UE that controls physical random access channel (PRACH) transmission power is provided. The processor of the UE is configured to select a random access (RA) channel occasion (RO) from several ROs associated with a single synchronization SS/PBCH block; determine whether the RO is within a subband full duplex (SBFD) region in time domain; if the RO is fully within the SBFD region: select a first preamble received target power and determine a current PRACH transmission power based on the first preamble received target power; if the RO is fully outside the SBFD region: select a second preamble received target power, where the second preamble received target power is different from the first preamble received target power; and determine the current PRACH transmission power based on the second preamble received target power; and transmit, to a BS, an RA preamble in the RO at the current PRACH transmission power.

### TECHNICAL FIELD

The technology generally relates to wireless communications, and more particularly to controlling the transmission power of Physical Random Access Channel (PRACH).

### BACKGROUND

With the tremendous growth in the number of connected devices and the rapid increase in user/network (NW) traffic volume, various efforts have been made to improve different aspects of wireless communication for next-generation radio communication systems, such as fifth-generation (5G) New Radio (NR), by improving data rate, latency, reliability, and mobility.

The 5G NR system is designed to provide flexibility and configurability to optimize NW services and types, thus accommodating various use cases, such as enhanced Mobile Broadband (eMBB), massive Machine-Type Communication (mMTC), and Ultra-Reliable and Low-Latency Communication (URLLC).

However, as the demand for radio access continues to increase, there is a need for further improvements in wireless communications in the next-generation radio communication systems.

### SUMMARY

In a first aspect of the present application, a user equipment (UE) is provided. The UE includes one or more non-transitory computer-readable media storing one or more computer-executable instructions for controlling PRACH transmission power; and ad at least one processor coupled to the one or more non-transitory computer-readable media. The at least one processor is configured to execute the one or more computer-executable instructions to cause the UE to select a random access (RA) channel occasion (RO) from several ROs associated with a single synchronization signal/physical broadcast channel (SS/PBCH) block; determine whether the RO is within a subband full duplex (SBFD) region in time domain; in a case that the RO is fully within the SBFD region in the time domain: select a first preamble received target power and determine a current PRACH transmission power based on the first preamble received target power; in a case that the RO is fully outside the SBFD region in the time domain: select a second preamble received target power, wherein the second preamble received target power is different from the first preamble received target power and determine the current PRACH transmission power based on the second preamble received target power; and transmit, to a base station (BS), an RA preamble in the RO at the current PRACH transmission power.

In an implementation of the first aspect, the at least one processor is further configured to execute the one or more computer-executable instructions to cause the UE to, in a case that the RO is partially within the SBFD region in the time domain: select one of the first or second preamble received target powers and determine the current PRACH transmission power based on the selected preamble received target power.

In another implementation of the first aspect, transmitting selecting one of the first or second preamble received target powers includes selecting one of the first or second preamble received target powers based on a radio resource control (RRC) parameter received from the BS.

In another implementation of the first aspect, the at least one processor is further configured to execute the one or more computer-executable instructions to cause the UE to, in a case that the RO is partially within the SBFD region in the time domain, select the first preamble received target power and determine the current PRACH transmission power based on the first preamble received target power.

In another implementation of the first aspect, the at least one processor is further configured to execute the one or more computer-executable instructions to cause the UE to, in a case that the RO is partially outside the SBFD region in the time domain, select the second preamble received target power; and determine the current PRACH transmission power based on the second preamble received target power.

In another implementation of the first aspect, the at least one processor is further configured to execute the one or more computer-executable instructions to cause the UE to receive the first and second preamble received target powers from the BS as RRC parameters.

In another implementation of the first aspect, the UE further includes a medium access control (MAC) layer unit; and a physical layer unit. The MAC layer unit is configured to select the RO from the several ROs associated with the single SS/PBCH block, determine whether the RO is within the SBFD region in the time domain, and select one of the first or second preamble received target powers. The physical layer unit is configured to transmit the RA preamble in the RO at the current PRACH transmission power.

In another implementation of the first aspect, the RO is a first RO, the at least one processor is further configured to execute the one or more computer-executable instructions to cause the UE to: determine that an RA response (RAR) corresponding to the transmitted preamble is not received from the BS within a RAR window; select a second RO from the several ROs associated with the single SS/PBCH block; determine whether the second RO is within an SBFD region in the time domain; in a case that the second RO is within the SBFD region in the time domain: select a first power ramping step and update the current PRACH transmission power based on the first power ramping step; in a case that the second RO is not within the SBFD region in the time domain: select a second power ramping step and update the current PRACH transmission power based on the second power ramping step; and retransmit the RA preamble in the second RO at the current PRACH transmission power.

In another implementation of the first aspect, the at least one processor is further configured to execute the one or more computer-executable instructions to cause the UE to, in a case that the second RO is partially within the SBFD region in the time domain, select one of the first or second power ramping steps and update the current PRACH transmission power based on the selected power ramping step.

In another implementation of the first aspect, selecting one of the first or second power ramping steps includes selecting one of the first or second power ramping steps based on RRC parameters received from the BS.

In another implementation of the first aspect, the at least one processor is further configured to execute the one or more computer-executable instructions to cause the UE to, in a case that the second RO is partially within the SBFD region in the time domain, select the first power ramping step and update the current PRACH transmission power based on the first power ramping step.

In another implementation of the first aspect, the at least one processor is further configured to execute the one or more computer-executable instructions to cause the UE to, in a case that the second RO is partially outside the SBFD region in the time domain, select the second power ramping step and update the current PRACH transmission power based on the second power ramping step.

In another implementation of the first aspect, the at least one processor is further configured to execute the one or more computer-executable instructions to cause the UE to set a first power ramping counter; set a second power ramping counter; in a case that the second RO is within the SBFD region in the time domain: increment the first power ramping counter and update the current PRACH transmission power further based on the first power ramping counter; in a case that the second RO is not within the SBFD region in the time domain: increment the second power ramping counter and determine the current PRACH transmission power further based on the second power ramping counter.

In another implementation of the first aspect, the at least one processor is further configured to execute the one or more computer-executable instructions to cause the UE to determine that a RAR corresponding to the retransmitted RA preamble is not received from the BS within the RAR window after the retransmission of the RA preamble in the second RO at the current PRACH transmission power; and iteratively select another RO from the several ROs, update the current PRACH transmission power based on whether the selected RO is within the SBFD region or outside the SBFD region in the time domain, and retransmit the RA preamble, in the selected RO, at the updated current transmission power, for a number of times.

In a second aspect, a method of controlling PRACH transmission power is provided. The method includes selecting an RO from several ROs associated with an SS/PBCH block; determining whether the RO is within an SBFD region in time domain; in a case that the RO is fully within the SBFD region in the time domain: selecting a first preamble received target power; and determining a current PRACH transmission power based on the first preamble received target power; in a case that the RO is not fully within the SBFD region: selecting a second preamble received target power, wherein the second preamble received target power is different from the first preamble received target power; and determining the current PRACH transmission power based on the second preamble received target power; and transmitting, to a BS, an RA preamble in the RO at the current PRACH transmission power.

### BRIEF DESCRIPTION OF THE DRAWINGS

The foregoing and other objects, features, and advantages of the technology disclosed herein will be apparent from the following more particular description of preferred embodiments as illustrated in the accompanying drawings in which reference characters refer to the same parts throughout the various views. The drawings are not necessarily to scale, emphasis instead being placed upon illustrating the principles of the technology disclosed herein.

FIG. 1 is a schematic diagram illustrating a radio communication system, according to an example implementation of the present disclosure.

FIGS. 2A and 2B are two diagrams illustrating parameters related to subcarrier spacing (SCS)-specific carriers, according to an example implementation of the present disclosure.

FIG. 3 is a diagram illustrating an example configuration of SCS-specific carriers, according to an example implementation of the present disclosure.

FIG. 4 is a diagrammatic view illustrating an example configuration of a resource grid, according to an example implementation and mode of the present disclosure.

FIG. 5 is a schematic block diagram illustrating a configuration example of a base station device, according to an example implementation of the present disclosure.

FIG. 6 is a schematic block diagram illustrating a configuration example of a terminal device, according to an example implementation of the present disclosure.

FIG. 7 is a diagram illustrating an example configuration of a synchronization signal/physical broadcast channel (SS/PBCH) block including a primary synchronization signal (PSS) and a secondary synchronization signal (SSS), according to an example implementation of the present disclosure.

FIG. 8 is a time-frequency diagram illustrating an example resource partitioning in a serving cell, according to an example implementation of the present disclosure.

FIGS. 9A-9B illustrate a flowchart of an example method/process of a CBRA procedure performed by a terminal device, according to an example implementation of the present disclosure.

FIGS. 10A-10B illustrate a flowchart of an example method/process performed by a terminal device to determine the PRACH transmission power using two power ramping counters, according to an example implementation of the present disclosure.

FIG. 11 is a flowchart illustrating an example method/process performed by a terminal device to determine the PRACH transmission power using two preamble received target powers, according to an example implementation of the present disclosure.

### DETAILED DESCRIPTION

The following description contains specific information pertaining to example implementations in the present disclosure. The drawings in the present disclosure and their accompanying detailed description are directed to merely example implementations. However, the present disclosure is not limited to merely these example implementations. Other variations and implementations of the present disclosure will occur to those skilled in the art. Unless noted otherwise, like or corresponding elements among the figures may be indicated by like or corresponding reference numerals. Moreover, the drawings and illustrations in the present disclosure are generally not to scale and are not intended to correspond to actual relative dimensions.

For the purposes of consistency and ease of understanding, like features may be identified (although, in some examples, not shown) by the same numerals in the example figures. However, the features in different implementations may differ in other respects, and thus may not be narrowly confined to what is shown in the figures.

The description uses the phrases “in one implementation,” or “in some implementations,” which may each refer to one or more of the same or different implementations. The term “coupled” is defined as connected, whether directly or indirectly through intervening components, and is not necessarily limited to physical connections. The term “comprising,” when utilized, means “including, but not necessarily limited to”; it specifically indicates open-ended inclusion or membership in the so-described combination, group, series, and the equivalent. In addition, the terms “system” and “network” herein may be used interchangeably.

As used herein, the term “and/or” should be interpreted to mean one or more items. For example, the phrase “A, B, and/or C” should be interpreted to mean any of: only A, only B, only C, A and B (but not C), B and C (but not A), A and C (but not B), or all of A, B, and C. As used herein, the phrase “at least one of” should be interpreted to mean one or more items. For example, the phrase “at least one of A, B, and C” or the phrase “at least one of A, B, or C” should be interpreted to mean any of: only A, only B, only C, A and B (but not C), B and C (but not A), A and C (but not B), or all of A, B, and C. As used herein, the phrase “one or more of” should be interpreted to mean one or more items. For example, the phrase “one or more of A, B and C” or the phrase “one or more of A, B or C” should be interpreted to mean any of: only A, only B, only C, A and B (but not C), B and C (but not A), A and C (but not B), or all of A, B, and C.

Additionally, for the purposes of explanation and non-limitation, specific details, such as functional entities, techniques, protocols, standard, and the like are set forth for providing an understanding of the described technology. In other examples, detailed descriptions of well-known methods, technologies, systems, architectures, and the like are omitted so as not to obscure the description with unnecessary details.

Persons skilled in the art will immediately recognize that any network function(s) or algorithm(s) described in the present disclosure may be implemented by hardware, software, or a combination of software and hardware. Described functions or algorithms may correspond to modules which may be software, hardware, firmware, or any combination thereof. The software implementation may include computer executable instructions stored on a computer-readable medium, such as a memory or other types of storage devices. For example, one or more microprocessors or general-purpose computers with communication processing capability may be programmed with corresponding executable instructions and carry out the described network function(s) or algorithm(s). The microprocessors or general-purpose computers may include of one or more Application-Specific Integrated Circuits (ASICs), programmable logic arrays, and/or one or more Digital Signal Processor (DSPs). Although some of the example implementations described in this specification are oriented to software installed and executing on computer hardware, nevertheless, alternative example implementations implemented as firmware, as hardware, or as a combination of hardware and software are well within the scope of the present disclosure.

The computer-readable medium includes, but is not limited to, Random Access Memory (RAM), Read Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication network architecture (e.g., a Long Term Evolution (LTE) system, an LTE-Advanced (LTE-A) system, an LTE-Advanced Pro system, or a 5G NR Radio Access Network (RAN)) typically includes at least one base station, at least one UE, and one or more optional network elements that provide connection towards a network. The UE communicates with the network (e.g., a Core Network (CN), an Evolved Packet Core (EPC) network, an Evolved Universal Terrestrial Radio Access network (E-UTRAN), a 5G Core (5GC), or an internet), through a radio communication network established by one or more base stations.

It should be noted that, in the present application, a UE (or a terminal device) may include, but is not limited to, a mobile station, a mobile terminal or device, a user communication radio terminal. For example, a UE may be a portable radio equipment, which includes, but is not limited to, a mobile phone, a tablet, a wearable device, a sensor, a vehicle, or a Personal Digital Assistant (PDA) with wireless communication capability. The UE is configured to receive and transmit signals over an air interface to one or more cells in a radio access network.

A base station (BS) may be configured to provide communication services according to at least one of the following Radio Access Technologies (RATs): Worldwide Interoperability for Microwave Access (WiMAX), Global System for Mobile communications (GSM, often referred to as 2G), GSM Enhanced Data rates for GSM Evolution (EDGE) Radio Access Network (GERAN), General Packet Radio Service (GPRS), Universal Mobile Telecommunication System (UMTS, often referred to as 3G) based on basic wideband-code division multiple access (W-CDMA), high-speed packet access (HSPA), LTE, LTE-A, evolved LTE (eLTE), for example, LTE connected to 5GC, NR (often referred to as 5G), and/or LTE-A Pro. However, the scope of the present application should not be limited to the above-mentioned protocols.

A BS may include, but is not limited to, a node B (NB) as in the UMTS, an evolved node B (eNB) as in the LTE or LTE-A, a radio network controller (RNC) as in the UMTS, a base station controller (BSC) as in the GSM/GSM Enhanced Data rates for GSM Evolution (EDGE) Radio Access Network (GERAN), a next-generation eNB (ng-eNB) as in an Evolved Universal Terrestrial Radio Access (E-UTRA) BS in connection with the 5GC, a next-generation Node B (gNB) as in the 5G Access Network (5G-AN), and any other apparatus capable of controlling radio communication and managing radio resources within a cell. The BS may connect to serve the one or more UEs through a radio interface to the network.

The BS may be operable to provide radio coverage to a specific geographical area using several cells included in the radio communication network. The BS may support the operations of the cells. Each cell may be operable to provide services to at least one UE within its radio coverage. Specifically, each cell (often referred to as a serving cell) may provide services to serve one or more UEs within its radio coverage (e.g., each cell may correspond to the Downlink (DL) and optionally Uplink (UL) resources to at least one UE within its radio coverage for DL and optionally UL packet transmission). The BS may communicate with one or more UEs in the radio communication system through the cells.

A cell may correspond to sidelink (SL) resources for supporting Proximity Service (ProSe) or Vehicle to Everything (V2X) services. Each cell may have overlapped coverage areas with other cells.

As discussed above, the frame structure for NR is to support flexible configurations for accommodating various next generation (e.g., 5G) communication requirements, such as Enhanced Mobile Broadband (eMBB), Massive Machine Type Communication (mMTC), Ultra-Reliable and Low-Latency Communication (URLLC), while fulfilling high reliability, high data rate and low latency requirements. The Orthogonal Frequency-Division Multiplexing (OFDM) technology as agreed in 3GPP may serve as a baseline for NR waveform. The scalable OFDM numerology, such as the adaptive sub-carrier spacing, the channel bandwidth, and the Cyclic Prefix (CP) may also be used. Additionally, two coding schemes are considered for NR: (1) Low-Density Parity-Check (LDPC) code and (2) Polar Code. The coding scheme adaption may be configured based on the channel conditions and/or the service applications.

Moreover, it should also be noted that in a transmission time interval of a single NR frame, a DL transmission period, a guard period, and UL transmission data may at least be included, where the respective portions of the DL transmission data, the guard period, and the UL transmission data should also be configurable, for example, based on the network dynamics of NR. In addition, sidelink resources may also be provided in an NR frame to support ProSe services, (E-UTRA/NR) sidelink services, or (E-UTRA/NR) V2X services.

A UE configured with multi-connectivity may connect to a Master Node (MN) as an anchor and one or more Secondary Nodes (SNs) for data delivery. Each one of these nodes may be formed by a cell group that includes one or more cells. For example, a Master Cell Group (MCG) may be formed by an MN, and a Secondary Cell Group (SCG) may be formed by an SN. In other words, for a UE configured with dual connectivity (DC), the MCG may be a set of one or more serving cells including the PCell and zero or more secondary cells. Conversely, the SCG may be a set of one or more serving cells including the PSCell and zero or more secondary cells.

As also described above, the Primary Cell (PCell) may be an MCG cell that operates on the primary frequency, in which the UE either performs the initial connection establishment procedure or initiates the connection reestablishment procedure. In the DC mode, the PCell may belong to the MN. The Primary SCG Cell (PSCell) may be an SCG cell in which the UE performs random access (e.g., when performing the reconfiguration with a sync procedure). In Multi-RAT Dual Connectivity (MR-DC), the PSCell may belong to the SN. A Special Cell (SpCell) may be referred to a PCell of the MCG, or a PSCell of the SCG, depending on whether the Medium Access Control (MAC) entity is associated with the MCG or the SCG. Otherwise, the term Special Cell may refer to the PCell. A Special Cell may support a Physical Uplink Control Channel (PUCCH) transmission and contention-based Random Access, and may always be activated. Additionally, a UE in an RRC_CONNECTED state that is not configured with the carrier aggregation/dual connectivity (CA/DC), may communicate with only one serving cell (SCell) which may be the primary cell. Conversely, for a UE in the RRC_CONNECTED state that is configured with the CA/DC a set of serving cells including the special cell(s) and all of the secondary cells may communicate with the UE.

Some mathematical expressions used in the present application are provided below.

Floor (CX) represents a floor function for the real number CX. For example, floor (CX) may represent a function that provides the largest integer within a range that does not exceed the real number CX.

Ceil (DX) represents a ceiling function to a real number DX. For example, ceil (DX) may be a function that provides the smallest integer within the range not less than the real number DX.

Mod (EX, FX) represents a function that provides the remainder obtained by dividing EX by FX.

Exp (GX) represents e\hat{ }GX. Here, e is the Napier number. Also, (HX)\hat{ }(IX) indicates IX to the power of HX.

According to one aspect of the present embodiment, a waveform formed based on the OFDM may be used in a radio communication system. An OFDM symbol defines a unit in the time domain of the waveform. Each OFDM symbol is converted to a time-continuous signal during a baseband signal generation. For example, the cyclic prefix-OFDM (CP-OFDM) may be used in the downlink transmission of the radio communication system. For example, either CP-OFDM or Discrete Fourier Transform-spread-Orthogonal Frequency Division Multiplex (DFT-s-OFDM) may be used in the uplink transmission of the radio communication system.

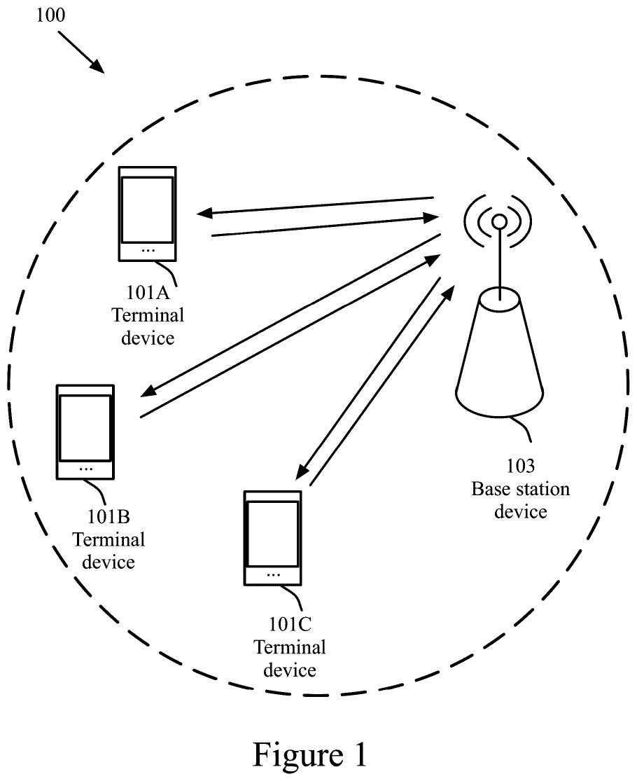

FIG. 1 is a schematic diagram illustrating a radio communication system, according to an example implementation of the present disclosure. In FIG. 1, the radio communication system 100 includes the terminal devices 101A to 101C and the base station device 103 (BS 103). The terms base station device, base station, and BS herein may be used interchangeably. The terms terminal device, user equipment, and UE herein may be used interchangeably.

The BS 103 may include one or more transmission/reception devices. When BS 103 is configured of multiple transmission/reception devices, each of the multiple transmission/reception devices may be arranged at a different position. A transmission/reception device may include a transmission device and/or a reception device.

The BS 103 may serve radio communication and provide one or more cells. A cell is defined as a set of resources used for a wireless communication. A cell may include one or both of a downlink component carrier and an uplink component carrier. A serving cell may include a downlink component carrier and two or more uplink component carriers.

One or more SubCarrier Spacing-specific (SCS-specific) carriers may be associated with one component carrier. Each SCS-specific carrier defines a carrier for a subcarrier-spacing configuration. For example, one SCS-specific carrier may be associated with either a downlink component carrier or an uplink component carrier. In another example, one SCS-specific carrier may be associated with both a downlink component carrier and an uplink component carrier.

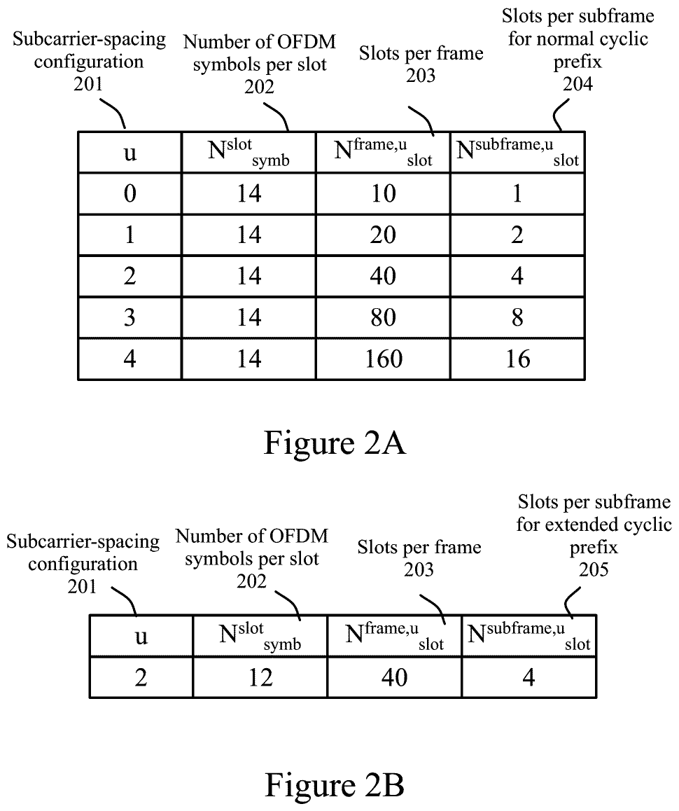

FIGS. 2A and 2B are two diagrams illustrating parameters related to SCS-specific carriers, according to an example implementation of the present disclosure. In FIGS. 2A and 2B, u 201 represents the subcarrier-spacing configuration. N^{slot}_{symb} 202 represents the number of OFDM symbols in a slot. N^{frame,u}ₛₗₒₜ 203 represents the number of slots in a radio frame. N^{subframe, u}ₛₗₒₜ 204 and N^{subframe, u}ₛₗₒₜ 205 represent the number of slots in a subframe for normal cyclic prefix and extended cyclic prefix, respectively.

In FIG. 2A, for example, when the subcarrier-spacing configuration u 201 is set to 2 and the CP configuration is set to normal Cyclic Prefix CP), the parameters are set to N^{slot}_{symb}=14, N^{frame, u}ₛₗₒₜ=40, and N^{subframe, u}ₛₗₒₜ=4. Further, in FIG. 2B, for example, when the subcarrier-spacing configuration u 201 is set to 2 and the CP configuration is set to an extended CP, the parameters are set to N^{slot}_{symb}=12, N^{frame, u}ₛₗₒₜ=40, N^{subframe, u}ₛₗₒₜ=4.

The time unit T_{c} represents the length of the time domain. The time unit T_{c} may be calculated by 1/(dfₘₐₓ*N_{f}), where dfₘₐₓ represents 480 kHz and N_{f}=4096. The constant k may be calculated by dfₘₐₓ*N_{f}/(df_{ref}N_{f, ref}). The constant k is 64 when df_{ref} is 15 kHz and N_{f,ref} is 2048.

Radio transmissions in the downlink and/or radio transmissions in the uplink may be organized into radio frames (or system frames, frames) of length T_{f}. T_{f} is calculated by (dfₘₐₓN_{f}/100)*Tₛ and (dfₘₐₓN_{f}/100)*Tₛ is equal to 10 ms. One radio frame may include ten subframes. The subframe length T_{sf} is calculated by dfₘₐₓN_{f}Tₛ/1000 and dfₘₐₓN_{f}Tₛ/1000 is equal to 1 ms. The number of OFDM symbols per subframe N^{subframe, u}_{symb} is calculated by N^{slot}_{symb}N^{subframe, u}ₛₗₒₜ.

The SCS of the OFDM-based waveform may be calculated by subcarrier-spacing configuration u. For example, the SCS may be calculated by 15000*2^{u}.

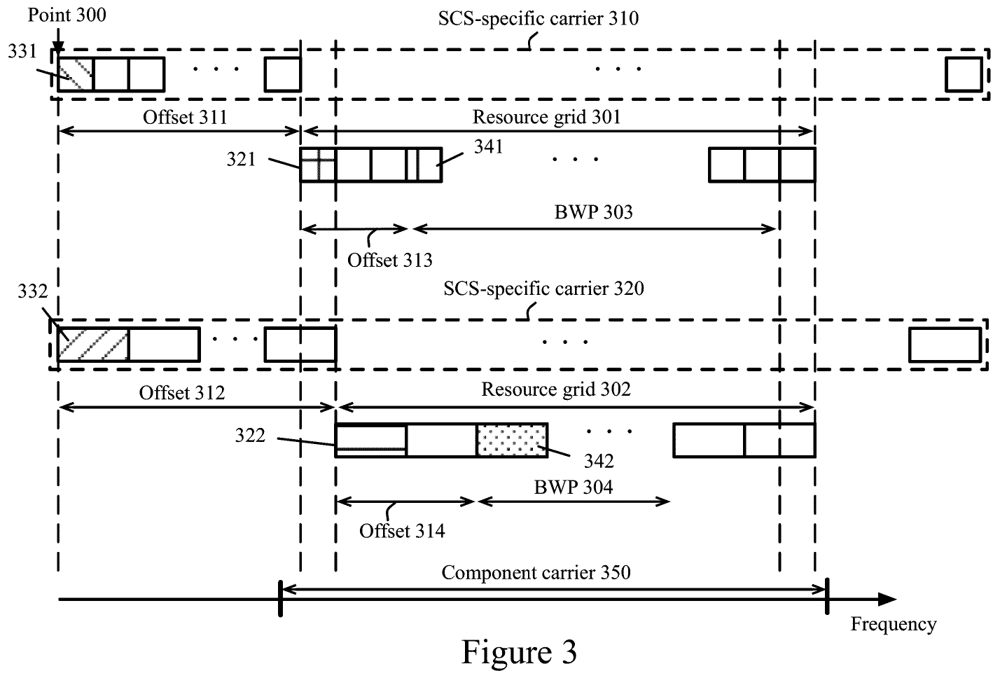

FIG. 3 is a diagram illustrating an example configuration of SCS-specific carriers, according to an example implementation of the present disclosure. The horizontal axis in FIG. 3 represents the frequency domain. FIG. 3 shows a configuration example of two SCS-specific carriers associated with the component carrier 350. In FIG. 3, u₁=u₂−1 is assumed.

Point 300 is an identifier for a specific subcarrier. Point 300 is also referred to as Point A. Common resource blocks (CRBs) for SCS-specific carrier 310 are defined with respect to Point 300. The CRB with index 0 is represented by the block 331. CRBs for SCS-specific carrier 320 are defined with respect to Point 300. The CRB with index 0 is represented by the block 332. The CRB with index 0 is defined as the CRB where a subcarrier in the CRB coincides with the subcarrier identified by Point 300.

In FIG. 3, the bandwidth of one CRB in the SCS-specific carrier 310 is a half bandwidth of one CRB in the SCS-specific carrier 320. In other implementations, the bandwidth of one CRB in the SCS-specific carrier 310 may be the same as the bandwidth of one CRB in the SCS-specific carrier 320.

The offset 311 is a Resource Block-level (RB-level) offset from the CRB with index 0 for SCS-specific carrier 310 to the reference point 321 of the resource grid 301. The reference point of the resource grid 301 is the block 321. The offset 312 is an RB-level offset from the CRB with index 0 for SCS-specific carrier 320 to the reference point 322 of the resource grid 302. The reference point of the resource grid 302 is the block 322.

The offset 313 is an RB-level offset from the reference point 321 of the resource grid 301 to the reference point 341 of the Band Width Part (BWP) 303. The reference point of the BWP 303 is the block 341. The offset 314 is an RB-level offset from the reference point 322 of the resource grid 301 to the reference point 342 of the BWP 304. The reference point of the BWP 304 is the block 342.

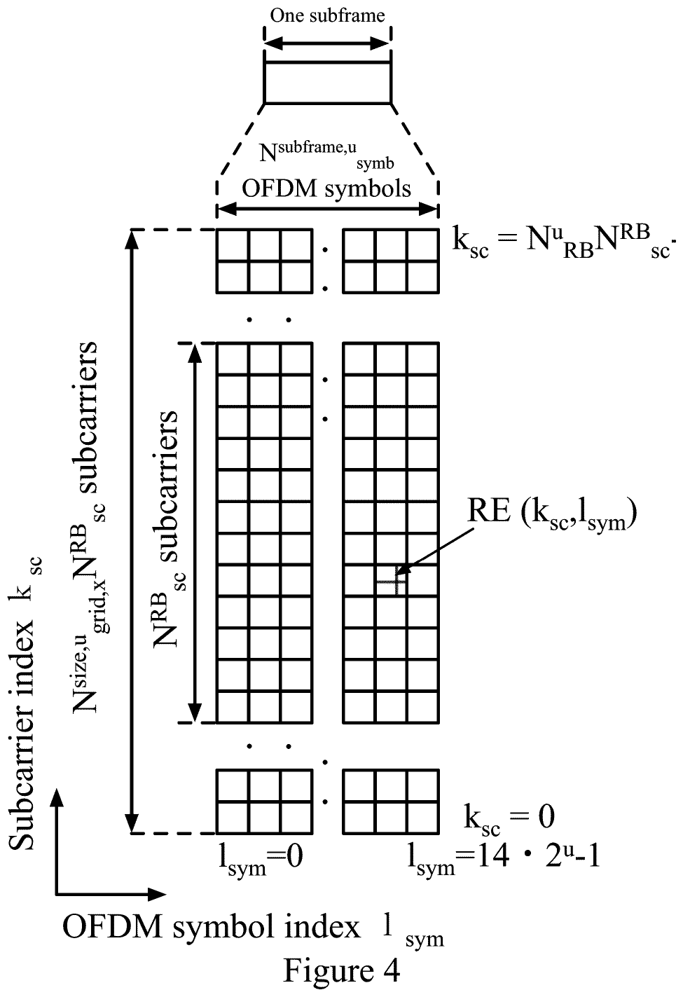

FIG. 4 is a diagrammatic view illustrating an example configuration of a resource grid, according to an example implementation and mode of the present disclosure. The horizontal axis represents OFDM symbol index l_{sym}. The vertical axis represents the subcarrier index k_{sc}. The resource grid includes N^{size,u}_{grid,x}N^{RB}_{sc} subcarriers and N^{subframes,u}_{symb} OFDM symbols. A resource specified by the subcarrier index k_{sc} and the OFDM symbol index l_{sym} in a resource grid is also referred to as (Resource Element (RE).

A resource block (RB) includes N^{RBs}c consecutive subcarriers. A resource block is a generic name for a CRB, a Physical Resource Block (PRB), and/or a Virtual Resource Block (VRB). In FIG. 4, N^{RB}_{sc} may be 12. CRBs are indexed in ascending order starting at CRB with index 0. PRBs are indexed in ascending order starting at its reference point of the BWP. A BWP is defined as a subset of resource blocks included in the resource grid. The BWP includes N^{size, u}_{BWP,i} resource blocks starting from the reference points of the BWP.

An antenna port may be defined such that the channel over which a symbol on the antenna port is conveyed may be inferred from the channel over which another symbol on the same antenna port is conveyed. The channel may correspond to a physical channel. The symbols may correspond to OFDM symbols. The symbols may correspond to resource block units. The symbols may correspond to resource elements.

Two antenna ports are said to be Quasi Co-Located (QCL) if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters. Carrier aggregation is a framework of communication using multiple aggregated serving cells or using multiple component carriers.

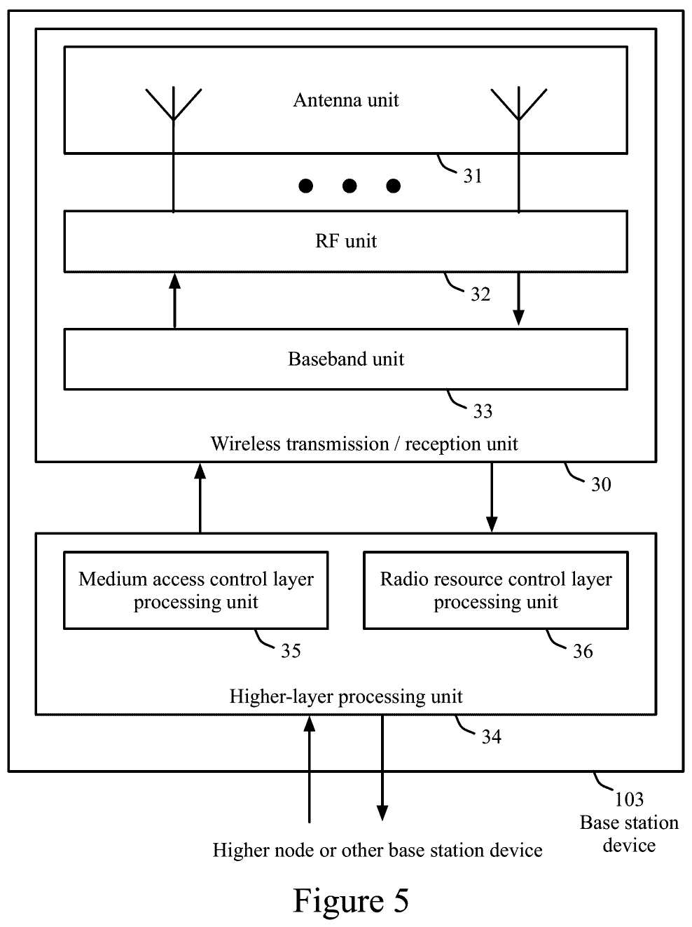

FIG. 5 is a schematic block diagram illustrating a configuration example of a base station device 103, according to an example implementation of the present disclosure. As shown in FIG. 5, the base station device 103 may include a part or all of the wireless transmission and reception unit (also referred to herein as physical layer processing unit) 30 and a higher-layer processing unit 34. The wireless transmission and reception unit 30 may include a part or all of an antenna unit 31, a Radio Frequency (RF) unit 32, and a baseband unit 33. The higher-layer processing unit 34 may include a part or all of a Medium Access Control (MAC) layer processing unit 35 and a Radio Resource Control (RRC) layer processing unit 36.

The wireless transmission and reception unit 30 may include a part (or all) of a wireless transmission unit 30a (not shown in the figure) and a wireless reception unit 30b (not shown in the figure). The configuration of the baseband unit 33 in the wireless transmission unit 30a and the configuration of the baseband unit 33 in the wireless reception unit 30b may be the same or different. The configuration of the RF unit 32 in the wireless transmission unit 30a and the configuration of the RF unit 32 in the wireless reception unit 30b may be the same or different. The configuration of the antenna unit 31 in the wireless transmission unit 30a and the configuration of the antenna unit 31 in the wireless reception unit 30b may be the same or different. The wireless transmission and reception unit 30 may include at least one processor (not shown in the figure) and one or more non-transitory computer-readable media (not shown in the figure) that store computer-executable instructions and data.

The higher-layer processing unit 34 may provide downlink data (e.g., transport blocks) to the wireless transmission and reception unit 30 (or the wireless transmission unit 30a). The higher-layer processing unit 34 may perform the processing of a part or all of the MAC layer, the Packet Data Convergence Protocol (PDCP) layer, the Radio Link Control (RLC) layer and the RRC layer. The higher-layer processing unit 34 may also include at least one processor (not shown in the figure) and one or more non-transitory computer-readable media (not shown in the figure) that store computer-executable instructions and data.

The MAC layer processing unit 35 may perform the processing of the MAC layer. The RRC layer processing unit 36 may perform the processing of the RRC layer. The RRC layer processing unit 36 may manage various RRC parameters of the terminal device 101.

The wireless transmission and reception unit 30 (or the wireless transmission unit 30a) may perform processing, such as encoding and modulation. The wireless transmission and reception unit 30 (or the wireless transmission unit 30a) generates a physical signal by encoding and modulating the downlink data. The wireless transmission and reception unit 30 (or the wireless transmission unit 30a) converts the OFDM symbols in the physical signal to a baseband signal by converting them to a time-continuous signal. The wireless transmission and reception unit 30 (or the wireless transmission unit 30a) transmits the baseband signal (or the physical signal) to the terminal device 101 via radio frequency. The wireless transmission and reception unit 30 (or the wireless transmission unit 30a) may arrange the baseband signal (or the physical signal) on a component carrier and transmit the baseband signal (or the physical signal) to the terminal device 101.

The wireless transmission and reception unit 30 (or the wireless reception unit 30b) may perform processing, such as demodulation and decoding. The wireless transmission and reception unit 30 (or the wireless reception unit 30b) separates, demodulates, and decodes the received physical signal, and provides the decoded information to the higher-layer processing unit 34. The wireless transmission and reception unit 30 (or the wireless reception unit 30b) may perform the channel access procedure prior to the transmission of the physical signal.

The RF unit 32 demodulates the radio signal received via the antenna unit 31 into an analog signal, and/or removes the extra frequency components. The RF unit 32 provides the processed analog signal to the baseband unit 33.

The baseband unit 33 converts the analog signal input from the RF unit 32 into a baseband signal. The baseband unit 33 separates a portion which corresponds to the CP from the baseband signal. The baseband unit 33 performs Fast Fourier Transformation (FFT) on the baseband signal from which the CP has been removed. The baseband unit 33 extracts components of the physical signal from the baseband signal. The baseband unit 33 performs Inverse Fast Fourier Transformation (IFFT) on the downlink data to generate time-continuous signal, adds a CP to the generated signal, generates a baseband signal, and converts the baseband signal into an analog signal. The baseband unit 33 provides the analog signal to the RF unit 32.

The RF unit 32 removes the extra frequency components from the analog signal input from the baseband unit 33, up-converts the analog signal to a radio frequency, and transmits it via the antenna unit 31. The RF unit 32 may have the function of controlling transmission power.

The terminal device 101 may configure one or more downlink BWPs per serving cell. The terminal device 101 may configure one or more uplink BWPs per serving cell.

The terminal device 101 may try to detect a Physical Downlink Shared Channel (PDSCH), a Physical Downlink Control Channel (PDCCH), and a Channel State Information-Reference Signal (CSI-RS) in the active downlink BWP. The terminal device 101 may transmit a Physical Uplink Control Channel (PUCCH) and a Physical Uplink Shared Channel (PUSCH) in the active uplink BWP. The active downlink BWP and the active uplink BWP are also referred to as active BWP.

The terminal device 101 may not receive the PDSCH, PDCCH, and CSI-RS in the downlink BWPs other than the active downlink BWP. The terminal device 101 may not transmit the PUCCH and PUSCH in the uplink BWPs other than the active uplink BWP. BWPs other than the active BWP is referred to as inactive BWPs.

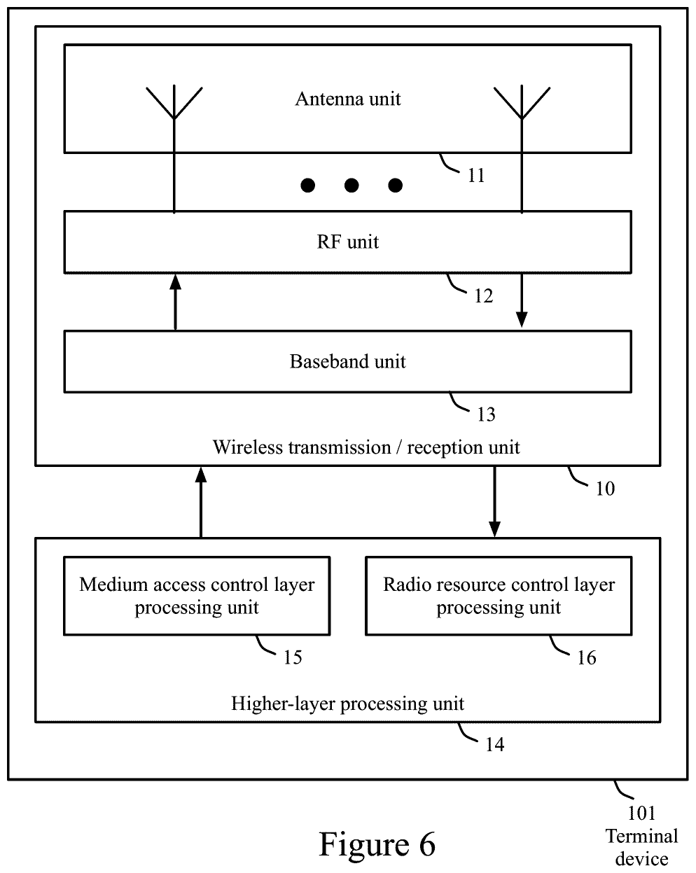

FIG. 6 is a schematic block diagram illustrating a configuration example of a terminal device, according to an example implementation of the present disclosure. The terminal device 101 may be any of the terminal devices 101A-101C, shown in FIG. 1. As shown in FIG. 6, the terminal device 101 may include a part or all of the wireless transmission and reception unit (also referred to herein as physical layer processing unit or physical layer unit) 10 and the higher-layer processing unit 14. The wireless transmission and reception unit 10 may include a part or all of the antenna unit 11, the RF unit 12, and the Baseband unit 13. The higher-layer processing unit 14 may include a part or all of the MAC layer processing unit (also referred to as the MAC entity) 15 and the RRC layer processing unit 16. The higher-layer processing unit 14 may include at least one processor (not shown in the figure) and one or more non-transitory computer-readable media (not shown in the figure) that store computer-executable instructions and data.

The wireless transmission and reception unit 10 may include a part of or all of the wireless transmission unit 10a (not shown in the figure) and the wireless reception unit 10b (not shown in the figure). The wireless transmission and reception unit 10 may include at least one processor (not shown in the figure) and one or more non-transitory computer-readable media (not shown in the figure) that store computer-executable instructions and data.

The configuration of the baseband unit 13 in the wireless transmission unit 10a and the configuration of the baseband unit 13 in the wireless reception unit 10b may be the same or different. The configuration of the RF unit 12 in the wireless transmission unit 10a and the RF unit 12 in the wireless reception unit 10b may be the same or different. The configuration of the antenna unit 11 in the wireless transmission unit 10a and the configuration of the antenna unit 11 in the wireless reception unit 10b may be the same or different.

The higher-layer processing unit 14 provides uplink data (transport blocks) to the wireless transmission and reception unit 10 (or the wireless transmission unit 10a). The higher-layer processing unit 14 may perform processing of the MAC layer, the PDCP layer, the RLC layer, and/or the RRC layer.

The MAC layer processing unit 15 in the higher-layer processing unit 14 may perform processing of the MAC layer. RRC layer processing unit 16 in the higher-layer processing unit 14 may perform the process of the RRC layer. RRC layer processing unit 16 manages various RRC parameters of the terminal device 101 based on RRC messages received from the base station device 103.

The wireless transmission and reception unit 10 (or the wireless transmission unit 10a) may perform processing, such as encoding and modulation. The wireless transmission and reception unit 10 (or the wireless transmission unit 10a) may generate a physical signal by encoding and modulating the uplink data. The wireless transmission and reception unit 10 (or the wireless transmission unit 10a) may convert OFDM symbols in the physical signal to a baseband signal by conversion to a time-continuous signal. The wireless transmission and reception unit 10 (or the wireless transmission unit 10a) may transmit the baseband signal (or the physical signal) to the base station device 103 via radio frequency. The wireless transmission and reception unit 10 (or the wireless transmission unit 10a) may arrange the baseband signal (or the physical signal) on a BWP (active uplink BWP) and transmit the baseband signal (or the physical signal) to the base station device 103.

The wireless transmission and reception unit 10 (or the wireless reception unit 10b) performs processing, such as demodulation and decoding. The wireless transmission and reception unit 10 (or the wireless reception unit 10b) may receive a physical signal in a BWP (active downlink BWP) of a serving cell. The wireless transmission and reception unit 10 (or the wireless reception unit 10b) may separate, demodulate, and decode the received physical signal, and provide the decoded information to the higher-layer processing unit 14. The wireless transmission and reception unit 10 (or the wireless reception unit 10b) may perform the channel access procedure prior to the transmission of the physical signal.

The RF unit 12 may demodulate the radio signal received via the antenna unit 11 into an analog signal, and/or removes extra frequency components. The RF unit 12 may provide the processed analog signal to the baseband unit 13. The baseband unit 13 may convert the analog signal input from RF unit 12 into a baseband signal. The baseband unit 13 may separate a portion which corresponds to CP from the baseband signal, perform FFT on the baseband signal from which the CP has been removed. The baseband unit 13 may extract components of the physical signal from the baseband signal.

The baseband unit 13 may perform IFFT on the uplink data to generate time-continuous signal, adds a CP to the generated signal, generate a baseband signal, and convert the baseband signal into an analog signal. The baseband unit 13 may provide the analog signal to the RF unit 12.

The RF unit 12 may remove extra frequency components from the analog signal input from the baseband unit 13, up-converts the analog signal to a radio frequency, and may transmit it via the antenna unit 11. RF unit 12 may have a function of controlling transmission power.

A physical signal is a generic term for physical downlink channels, physical downlink signals, physical uplink channels, and physical uplink signals. The physical channel is a generic term for physical downlink channels and physical uplink channels.

A physical uplink channel corresponds to a set of REs that carry one or both of information originating from the higher-layer and the Uplink Control Information (UCI). In the radio communication system according to one aspect of the present embodiments, a part or all of the PUCCH, PUSCH, and/or a Physical Random Access Channel (PRACH) may be used.

A PUCCH may be used to transmit the UCI. A PUCCH may be sent to deliver (transmit, convey) uplink control information. The UCI may be mapped to the PUCCH. The terminal device 101 may transmit a PUCCH in which the UCI is mapped. The base station device 103 may receive the PUCCH in which the UCI is mapped.

The Channel State Information (CSI) may be deemed as a type of UCI. The CSI is used to convey information related to the propagation path between the terminal device 101 and the base station device 103.

The Hybrid Automatic Repeat request ACKnowledgement (HARQ-ACK) information may also be deemed as a type of UCI. The HARQ-ACK information is used to convey whether the downlink data has been successfully decoded or not.

The Scheduling Request (SR) may also be deemed as a type of UCI. The SR is used to request an uplink resource (a PUSCH or a UL-SCH).

Uplink control information (uplink control information bit, uplink control information sequence, uplink control information type) includes at least part or all of the CSI, SR, and HARQ-ACK.

The CSI may include at least part or all of a channel quality indicator (CQI), a Precoder Matrix Indicator (PMI), and a Rank Indicator (RI). CQI is an indicator related to channel quality (e.g., propagation quality) or physical channel quality, and PMI is an indicator related to a precoder. RI is an indicator related to transmission rank (or the number of transmission layers).

The CSI may be provided at least based on receiving one or more physical signals (e.g., one or more CSI-RSs) used at least for channel measurement. The CSI may be selected by a terminal device at least based on receiving one or more physical signals used for channel measurement. Channel measurements may include interference measurements.

A PUSCH may be used to transmit one or both of a transport block and UCI. A PUSCH may be sent to deliver (transmit, convey) one or both of a transport block and uplink control information. The terminal device 101 may transmit a PUSCH in which one or both of a transport block and UCI is mapped. The base station device 103 may receive the PUSCH in which the one or both of the transport block and the UCI is mapped.

A PRACH may be used to transmit a random-access preamble. A PRACH may be sent to deliver (transmit, convey) an index of a random-access preamble. The terminal device 101 may transmit a PRACH. The base station device 103 may receive the PRACH.

For a given PRACH occasion (RACH occasion, RO), 64 random-access preambles are defined. The random-access preamble is specified (determined, given) based on the cyclic shift Cᵥ of the PRACH and the sequence index u for the PRACH.

A physical uplink signal corresponds to a set of REs. A physical uplink signal may not carry information generated in the higher-layer. The terminal device 101 may transmit a physical uplink signal. The base station device 103 may receive the physical uplink signal. In the radio communication system according to one aspect of the present embodiment, a part or all of UpLink Demodulation Reference Signal (UL DMRS), SRS (Sounding Reference Signal (SRS), UpLink Phase Tracking Reference Signal (UL PTRS) may be used.

UL DMRS is a generic name of a DMRS for a PUSCH and a DMRS for a PUCCH. A set of antenna ports of a DMRS for a PUSCH may be given based on a set of antenna ports for the PUSCH. For example, a set of DMRS antenna ports for a PUSCH may be the same as a set of antenna ports for the PUSCH.

A PUSCH and a DMRS for the PUSCH is collectively referred to as PUSCH. A set of antenna ports of a DMRS for a PUCCH may be given based on a set of antenna ports for the PUCCH. For example, a set of DMRS antenna ports for a PUCCH may be the same as a set of antenna ports for the PUCCH. A PUCCH and a DMRS for the PUCCH is collectively referred to as PUCCH.

A physical downlink channel corresponds to a set of REs that carry one or both of information originating from the higher-layer and Downlink Control Information (DCI). In the radio communication system according to one aspect of the present embodiment, a part or all of Physical Broadcast Channel (PBCH), Physical Downlink Control Channel (PDCCH), and Physical Downlink Shared Channel (PDSCH) may be used.

A PBCH may be used to transmit a Master Information Block (MIB). A PBCH may be sent to deliver (transmit, convey) a MIB. The terminal device 101 may receive a PBCH. The base station device 103 may transmit the PBCH.

A PDCCH may be used to transmit DCI. A PDCCH may be sent to deliver (transmit, convey) DCI. The terminal device 101 may receive a PDCCH in which DCI is mapped. The base station device 103 may transmit the PDCCH in which the DCI is mapped.

The DCI format includes a set of information fields. Each information field may mask a bit sequence of the DCI. Bits masked by an information field is associated with a specific meaning associated with the information field.

Several DCI formats may be used in the radio communication system according to one aspect of the present embodiment. Several example DCI formats are provided.

DCI format 0_0 is used for scheduling a PUSCH for a cell. The DCI format 0_0 includes a part or all of Information fields 1A to 1E. Information field 1A is a DCI format identification field. Information field 1B is a Frequency Domain Resource Assignment (FDRA) field. Information field 1C is a Time Domain Resource Assignment (TDRA) field. Information field 1D is a frequency-hopping flag field. Information field 1E is a Modulation-and-Coding-Scheme (MCS) field.

A DCI format identification field may indicate whether a DCI format including the DCI format identification field is an uplink DCI format or a downlink DCI format. The DCI format identification field included in the DCI format 0_0 indicates that the DCI format 0_0 is an uplink DCI format.

A FDRA field in a DCI format may be used to indicate assignment of frequency resources for a physical channel scheduled by the DCI format. For example, the FDRA field may indicate the number of RBs, X, for PUSCH.

A TDRA field in a DCI format may be used to indicate assignment of time resources for a physical channel scheduled by the DCI format.

A frequency-hopping flag field in a DCI format may be used to indicate whether frequency-hopping is applied to a physical channel scheduled by the DCI format.

A MCS field in a DCI format may be used to indicate one or both of a modulation scheme for a physical channel scheduled by the DCI format and a target code rate for the physical channel. The target code rate is used to determine a Transport Block Size (TBS) for the physical channel.

The DCI format 0_0 may not include fields used for a CSI request. That is, CSI may not be requested by the DCI format 0_0.

The DCI format 0_0 may not include a carrier indicator field. If an uplink DCI format does not include a carrier indicator field, the terminal device 101 may determine that an uplink component carrier on which a PUSCH scheduled by the uplink DCI format is mapped is an uplink component carrier in a serving cell which includes a downlink component carrier on which a PDCCH with the uplink DCI format is mapped.

The DCI format 0_0 may not include a BWP indicator field. If a DCI format does not include a BWP indicator field, the terminal device 101 may determine that active BWP change has not been triggered by the DCI format.

DCI format 0_1 may be used for scheduling of a PUSCH for a cell. The DCI format 0_1 includes a part or all of Information fields 2A to 2H. Information field 2A is a DCI format identification field. Information field 2B is a FDRA field. Information field 2C is a TDRA field. Information field 2D is a frequency-hopping flag field. Information field 2E is an MCS field. Information field 2F is a CSI request field. Information field 2G is a BWP field. Information field 2H is a carrier indicator field.

The DCI format identification field in the DCI format 01 may indicate that the DCI format 0_1 is an uplink DCI format.

The CSI request field may be used to request CSI reporting.

If the DCI format 0_1 includes a BWP field, the BWP field may be used to indicate an uplink BWP on which a PUSCH scheduled by the DCI format 0_1 is mapped.

If the DCI format 0_1 includes the carrier indicator field, the carrier indicator field may be used to indicate an uplink component carrier on which a PUSCH is mapped.

DCI format 10 may be used for scheduling of a PDSCH for a cell. The DCI format 1_0 includes a part or all of Information fields 3A to 3F. Information field 3A is a DCI format identification field. Information field 3B is a FDRA field. Information field 3C is a TDRA field. Information field 3D is an MCS field. Information field 3E is a PDSCH-to-HARQ-feedback indicator field. Information field 3F is a PUCCH resource indicator field. The DCI format identification field in the DCI format 1_0 indicates that the DCI format 1_0 is a downlink DCI format.

The PDSCH-to-HARQ-feedback timing indicator field may be used to indicate the offset (K1) from a slot in which the last OFDM symbol of a PDSCH scheduled by the DCI format is included to another slot in which the first OFDM symbol of a PUCCH triggered by the DCI format 1_0 is mapped. The PUCCH resource indicator field may be used to indicate a PUCCH resource.

The DCI format 1_0 may not include the carrier indicator field. If a downlink DCI format does not include the carrier indicator field, the terminal device 101 may determine that a downlink component carrier on which a PDSCH scheduled by the downlink DCI format is mapped is the downlink component carrier on which the PDCCH with the DCI format 1_0 is mapped. The DCI format 1_0 may not include the BWP field.

The DCI format 1_1 may be used for scheduling of a PDSCH for a cell. The DCI format 1_1 includes a part or all of Information fields 4A to 4H. Information field 4A is a DCI format identification field. Information field 4B is a FDRA field. The 4C is a TDRA field. Information field 4D is an MCS field. Information field 4E is a PDSCH-to-HARQ-feedback indicator field. Information field 4F is a PUCCH resource indicator field. Information field 4G is a BWP field. Information field 4H is a carrier indicator field. The DCI format identification field in the DCI format 11 may indicate that the DCI format 1_1 is a downlink DCI format.

A PDSCH may be used to transmit a transport block. A PDSCH may be sent to deliver (transmit, convey) a transport block. The base station device 103 may transmit a PDSCH. The terminal device 101 may receive the PDSCH.

A physical downlink signal corresponds to a set of REs. A physical downlink signal may not carry the information generated in the higher-layer. The base station 103 transmits a physical downlink signal. The terminal device 101 may receive the physical downlink signal. In the radio communication system according to one aspect of the present embodiment, at least a part or all of a Synchronization signal (SS), DownLink DeModulation Reference Signal (DL DMRS), Channel State Information-Reference Signal (CSI-RS), and DownLink Phase Tracking Reference Signal (DL PTRS) may be used.

A synchronization signal may be used to synchronize in the frequency domain and time domain for downlink. The synchronization signal is a generic name of Primary Synchronization Signal (PSS) and Secondary Synchronization Signal (SSS).

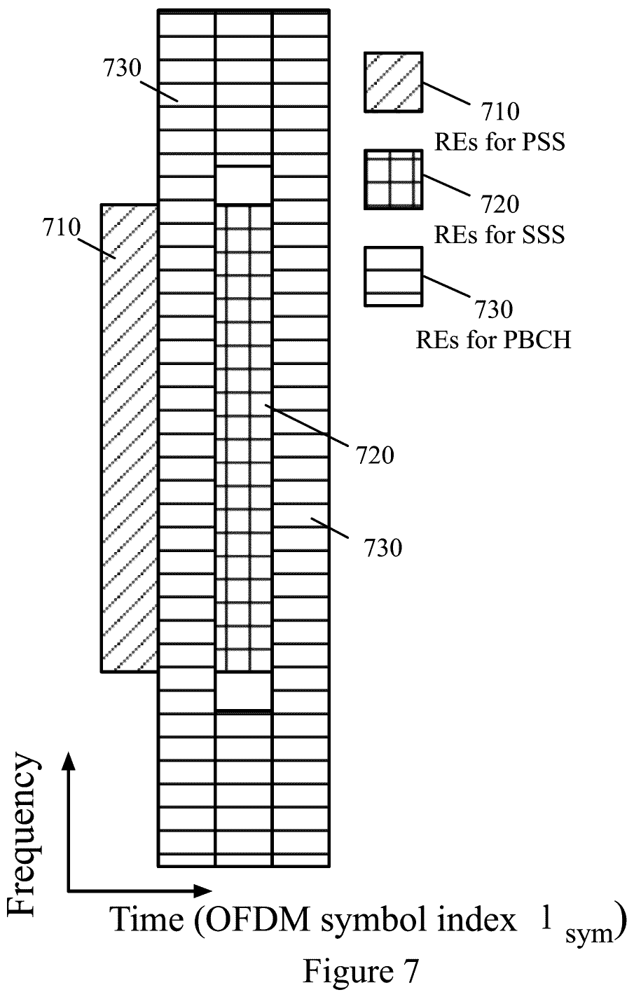

FIG. 7 is a diagram illustrating an example configuration of a synchronization signal/physical broadcast channel (SS/PBCH) block including a primary synchronization signal (PSS) and a secondary synchronization signal (SSS), according to an example implementation of the present disclosure. In FIG. 7, the horizontal axis represents the OFDM symbol index 1_{sym}, and the vertical axis represents the frequency domain. The shaded blocks 710 represent a set of REs for the PSS. The block of grid lines 720 represents a set of REs for the SSS. Also, the blocks in the horizontal line 730 represent a set of REs for the PBCH and a set of REs for a DMRS for the PBCH.

The SS/PBCH block in FIG. 7 includes a PSS, an SSS, and a PBCH. The SS/PBCH block includes 4 consecutive OFDM symbols and 240 subcarriers. The PSS is allocated to the 57th to 183rd subcarriers in the first OFDM symbol. The SSS is allocated to the 57th to 183rd subcarriers in the third OFDM symbol. The first to 56th subcarriers of the first OFDM symbol may be set to zero. The 184th to 240th subcarriers of the first OFDM symbol may be set to zero. The 49th to 56th subcarriers of the third OFDM symbol may be set to zero. The 184th to 192nd subcarriers of the third OFDM symbol may be set to zero. In the first to 240th subcarriers of the second OFDM symbol, the PBCH is allocated to subcarriers in which the DMRS for the PBCH is not allocated. In the first to 48th subcarriers of the third OFDM symbol, the PBCH is allocated to subcarriers in which the DMRS for the PBCH is not allocated. In the 193rd to 240th subcarriers of the third OFDM symbol, the PBCH is allocated to subcarriers in which the DMRS for the PBCH is not allocated. In the first to 240th subcarriers of the 4th OFDM symbol, the PBCH is allocated to subcarriers in which the DMRS for the PBCH is not allocated.

The antenna ports of the PSS, the SSS, the PBCH, and the DMRS for the PBCH in an SS/PBCH block may be identical. DL DMRS is a generic name of a DMRS for a PBCH, a DMRS for a PDSCH and a DMRS for a PDCCH.

A set of antenna ports of a DMRS for a PDSCH may be given based on a set of antenna ports for the PDSCH. For example, a set of DMRS antenna ports for a PDSCH may be the same as a set of antenna ports for the PDSCH.

A PDSCH and a DMRS for the PDSCH is collectively referred to as PDSCH. A set of antenna ports of a DMRS for a PDCCH may be given based on a set of antenna ports for the PDCCH. For example, a set of DMRS antenna ports for a PDCCH may be the same as a set of antenna ports for the PDCCH. A PDCCH and a DMRS for the PDCCH is collectively referred to as PDCCH.

A Broadcast Channel (BCH), an Uplink-Shared Channel (UL-SCH). and a Downlink-Shared Channel (DL-SCH) are transport channels. A channel used in the MAC layer is called a transport channel. A unit of transport channel used in the MAC layer is also called transport block (TB) or MAC Protocol Data Unit (MAC PDU). In the MAC layer, control of Hybrid Automatic Repeat request (HARQ) is performed for each transport block. The transport block is a unit of data delivered by the MAC layer to the physical layer. In the physical layer, transport blocks are mapped to codewords and modulation processing is performed for each codeword.

One UL-SCH and one DL-SCH may be provided for each serving cell. BCH may be given to PCell. BCH may not be given to PSCell and SCell.

A Broadcast Control Channel (BCCH), a Common Control Channel (CCCH), and a Dedicated Control Channel (DCCH) are logical channels. The BCCH is a channel of the RRC layer used to deliver MIB or system information. The CCCH may be used to transmit a common RRC message in multiple terminal devices. The DCCH may be used to transmit a dedicated RRC message to a terminal device.

The BCCH in the logical channel may be mapped to the BCH or the DL-SCH in the transport channel. The CCCH in the logical channel may be mapped to the DL-SCH or the UL-SCH in the transport channel. The DCCH in the logical channel may be mapped to the DL-SCH or the UL-SCH in the transport channel.

The UL-SCH in the transport channel may be mapped to a PUSCH in the physical channel. The DL-SCH in the transport channel may be mapped to a PDSCH in the physical channel. The BCH in the transport channel may be mapped to a PBCH in the physical channel.

A higher-layer parameter is a parameter in an RRC message or a MAC CE (Control Element). A higher-layer parameter may be a cell-specific parameter or a UE-specific parameter. A cell-specific parameter is a parameter including a common configuration in a cell. A UE-specific parameter is a parameter including a configuration that may be configured differently for each UE.

The BS 103 may indicate change of cell-specific parameters by reconfiguration with random-access. The BS 103 may indicate change of UE-specific parameters by reconfiguration with or without random-access.

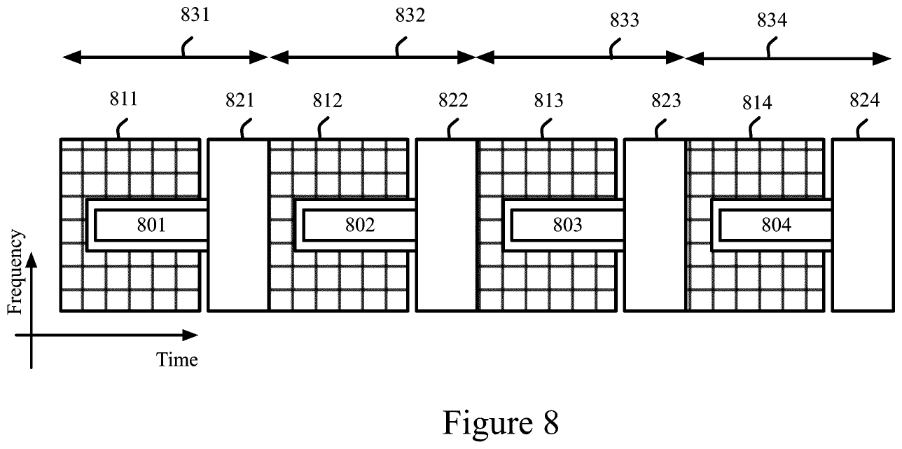

FIG. 8 is a time-frequency diagram illustrating an example resource partitioning in a serving cell, according to an example implementation of the present disclosure. The horizontal axis represents the time domain. The vertical axis represents the frequency domain. The regions 801, 802, 803, and 804 represent the time-frequency resources for a UL subband. The regions 811, 812, 813, and 814 with grid lines represent DL regions. The regions 821, 822, 823, and 824 represent UL regions. The lines 831, 832, 833, and 834 represent periods of the time division duplexing (TDD) pattern. Each region represents a resource for each SS/PBCH block with a different index. Time domain guard periods are placed on a switching location from DL to UL. Frequency domain guard bands are placed on a boundary of DL and UL.

TDD pattern is a pattern including a part of all the DL region, flexible region, and UL region. In FIG. 8, the TDD pattern includes the DL region and the UL region. The time domain guard period between the DL region and UL region may be as part of the DL region, as part of the UL region, or flexible region. The TDD pattern may be configured based on one or more RRC parameters provided by the RRC layer. The length of the pattern may be configured based on one or more RRC parameters provided by the RRC layer.

The UL subband may be configured in one or both of the DL region and the time domain guard period. The time domain resource of the UL subband may be configured by one or more RRC parameters provided by the RRC layer.

The time domain resource of the UL subband may be configured by one or more first RRC parameters used to indicate a periodicity of the UL subband, one or more second RRC parameters used to indicate the starting slot of the UL subband in each period, and one or more third RRC parameters used to indicate the length of the UL subband in each period in number of slots. For example, in a case that the periodicity is 20 slots, the starting slot is the 3rd slot, and the length is 11 slots, the terminal device 101 determines that the UL subband with length of 11 slots starting at the 3rd slot is placed in each periodicity.

One or more first RRC parameters used to indicate the periodicity may be one or more RRC parameters different from the one or more RRC parameters used to indicate the periodicity of the TDD pattern. For example, the one or more RRC parameters used to indicate the periodicity of the TDD pattern may be reused to indicate the periodicity of the UL subband. For example, the terminal device 101 may assume the periodicity of the UL subband is the same as the periodicity of the TDD pattern.

One or more fourth RRC parameters may be used to indicate the starting OFDM symbol of the UL subband in the starting slot. For example, one or more fifth RRC parameters may be used to indicate the length of the UL subband in number of symbols. For example, the frequency domain resource of the UL subband may be configured by one or more first RRC parameters used to indicate the starting RB of the UL subband and one or more second RRC parameters used to indicate the length of the UL subband in number of RBs.

The UL subband may be configured in an SCS-specific carrier. Therefore, in this case, the RRC parameters used to indicate resources of the UL subband may be provided per SCS-specific carrier. The UL subband may be configured in a BWP. Therefore, in this case, the RRC parameters used to indicate resources of the UL subband may be provided per BWP.

Using the UL subband, the base station device 103 may perform simultaneous transmission and reception at a time. For example, in a time occasion with UL subband 801, the base station device 103 performs transmission of physical downlink channels in the region 811 and reception of physical uplink channels in the region 801 at a time. The time occasion where the UL subband is mapped is referred to as a SubBand Full Duplex (SBFD) region.

Various physical layer configurations may be independently provided for the SBFD region and non-SBFD region. For example, the base station device 103 may use different QCL properties for the SBFD region and the non-SBFD region. The base station device 103 may use different settings for the components of the RF unit 32. For example, the components may include analog filters, amplifiers, or clocks. The terminal device 101 may obtain information related to the various physical layer configurations from the base station device 103.

Random-access (RA) may be used for various purposes. For example, RA may be used for scheduling requests or uplink timing synchronization. The RA procedures are crucial for establishing initial communication between the UE and the network, in scenarios such as initial network access, handovers, and when the UE needs to move from an idle state to a connected state.

At least two modes are available for RA: (1) Contention-Based Random-Access (CBRA) and (2) Contention-Free Random-Access (CFRA). In a CBRA procedure, the UE may select an RA preamble from a pool shared with other UEs. In a CBRA procedure, multiple UEs may select the same preamble. In a CFRA procedure, the BS may allocate a dedicated RA preamble for the UE to ensure different UEs use different preambles.

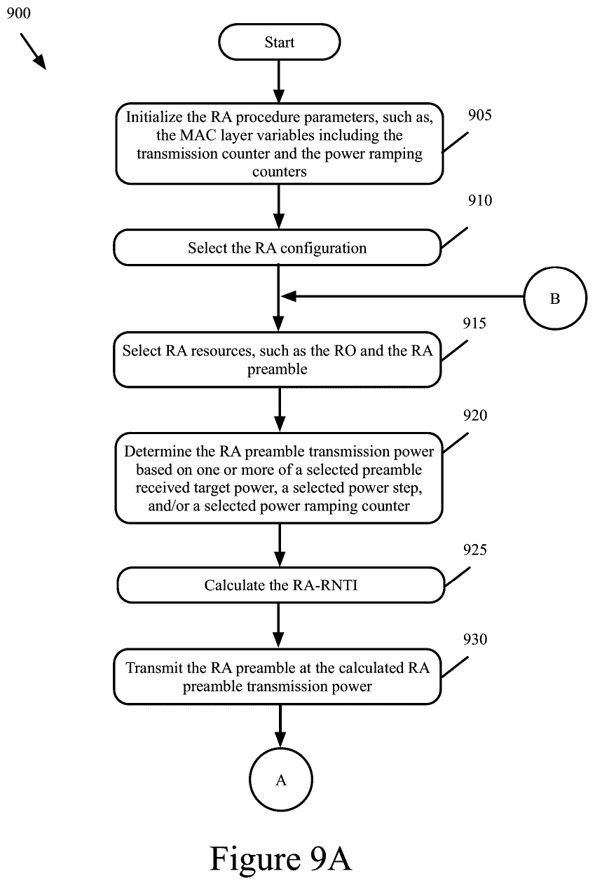

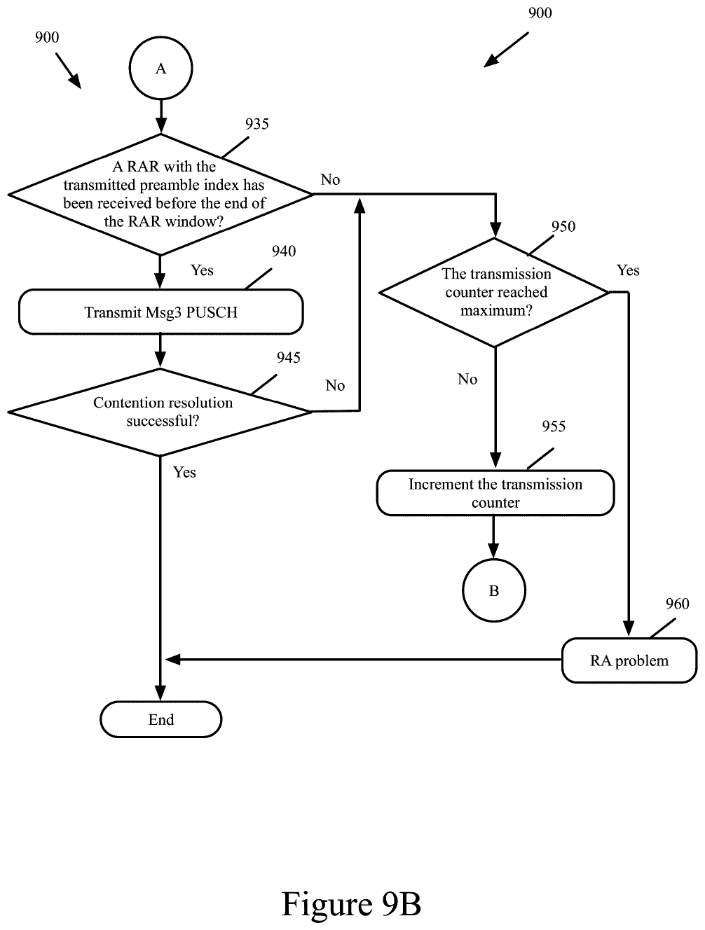

FIGS. 9A-9B illustrate a flowchart of an example method/process 900 of a CBRA procedure performed by a terminal device, according to an example implementation of the present disclosure. The process 900 may be performed by at least one processor of the terminal device 101, shown in FIG. 6. For example, the processor of the terminal device 101 may perform the process 900 in the MAC layer processing unit (the MAC entity) 15 and the wireless transmission and reception unit (the physical layer unit) 10.

The process 900 may initialize (at block 905) the RA procedure parameters. For example, the MAC entity 15 may reset MAC layer parameters, such as, a part or all of a transmission counter C_{TX}, and a power ramping counter Cₚ. For example, the MAC entity 15 may set the C_{TX} to 1 and the MAC entity may set the Cₚ to 1. The MAC entity, in some embodiments, may use two power ramping counters Cₚ₁ and Cₚ₂. The two power ramping counters Cₚ₁ and Cₚ₂ may, for example, be initialized to 1.

The process 900 may select (at block 910) the RA configuration. In a case that the terminal device 101 is provided with multiple RA configurations, the MAC entity may select an RA configuration from the multiple RA configurations. In a case that the terminal device 101 is provided with multiple feature combinations, the MAC entity may select one feature combination suitable for the RA. Each feature combination may be associated with the respective RA configurations. The example of the features may include coverage enhancement (CovEnh) to indicate the need for coverage enhancement to the network, slicing to indicate the need for prioritization and isolation of a slice to the network, reduced capabilities (RedCap) to indicate the reduced capabilities of the UE to the network, small data transmission (SDT) to indicate the small data transmission procedure, etc.

The process 900 may select (at block 915) the RA resources. In the RA resource selection, an RA preamble index may be selected. Furthermore, an RA channel occasion (RO) may be selected for PRACH transmission. An RA configuration may provide multiple ROs over time-frequency domain. For example, with reference to FIG. 8, several ROs may be provided in the SBFD regions 801-804 and/or in the non-SBFD regions 821-824. Some of the ROs may be partially in an SBFD region 801-804 and partially in a non-SBFD region 821-824.

Each RO may be associated with one or more SS/PBCH block indices. The MAC entity 15 may determine the association between the SS/PBCH blocks and the ROs. In a case where a single SS/PBCH block is configured, the MAC entity 15 may determine that all the ROs derived from the selected RA configuration are associated with the single SS/PBCH block. In a case where multiple SS/PBCH blocks with different indices are configured, the MAC entity 15 may select one SS/PBCH block from the multiple SS/PBCH blocks. The MAC entity 15 may determine one RO associated with the selected SS/PBCH block using the association between the SS/PBCH blocks and ROs.

The process 900 may determine (at block 920) a transmission power for transmission of the RA preamble based on one or more of a selected preamble received target power, a selected power step, and/or a selected power ramping counter. The RA preamble may be transmitted using the selected RA preamble index and the selected RO. The MAC entity 15 may instruct the physical layer unit 10 to transmit the PRACH using a transmission power that is determined based on a parameter PREAMBLE_RECEIVED_TARGET_POWER (referred to as P_{target}). The parameter P_{target} may be calculated using the power ramping counter Cₚ. For example, P_{target} may be calculated as shown in Equation (1):

$${P}_{target} = {p}_{configured} + Δ + ( {C}_{p} - 1 ) * {P}_{step} \qquad Equation ( 1 )$$

Here, p_{configured} is a value provided by one or more RRC parameters. The p_{configured} may be a value representing a configured preamble received target power for the PRACH, A is a value associated with a preamble format used to transmit the PRACH, and pₛₜₑₚ is a value representing the step of power ramping. The pₛₜₑₚ may be determined by one or more RRC parameters.

As described below, the MAC entity 15 may select a different configured preamble received target power p_{configured}, a different power ramping step pₛₜₑₚ and/or a different power ramping counter Cₚ, based on whether the selected RO is in an SBFD region (e.g., one of the regions 801-804 shown in FIG. 8) and/or in a non-SBFD region (e.g., one of the regions 821-824 shown in FIG. 8).

According to the instruction from the MAC entity 15, the wireless transmission and reception unit 10 may transmit a PRACH using the selected random-access preamble index and the RO. The wireless transmission and reception unit 10 may determine transmission power P_{PRACH} for the PRACH. The wireless transmission and reception unit 10 may determine the transmission power P_{PRACH} using the parameter P_{target}. For example, the transmission power P_{PRACH} may be calculated as shown in Equation (2):

$${P}_{PRACH} = min ( {P}_{CMA X} , {P}_{target} + PL ) \qquad Equation ( 2 )$$

Here, P_{CMAX} denotes the configured maximum transmission power for the serving cell and PL may be calculated based on referenceSignalPower (reference signal power received (RSRP)). The referenceSignalPower is a value provided by one or more RRC parameters. The one or more RRC parameters may include an RRC parameter representing SS/PBCH block transmission power. The RSRP may be an unfiltered RSRP or a higher layer filtered RSRP. The RSRP may be calculated via measurement of the SS/PBCH blocks with the selected SS/PBCH block index. It should be noted that the detectability of the PRACH by the BS depends on the received power at the BS. Therefore, the transmission power for the PRACH (e.g., the P_{PRACH} calculated by Equation (2)) is calculated as a function of the received power by the BS (e.g., the P_{target} calculated in Equation (1)).

In the RA, for a terminal device 101 that is capable of PRACH transmission in the SBFD regions, different power control parameters may be used for PRACH transmissions in the SBFD regions and PRACH transmissions in the non-SBFD regions. For example, one RACH resource configuration may include two different power control settings.

The first power control setting may include RRC parameters for the SBFD regions (e.g., one of the regions 801-804 shown in FIG. 8). The second power control setting may include RRC parameters for the non-SBFD regions (e.g., one of the regions 821-824 shown in FIG. 8).

The MAC entity 15, in some embodiments, may adaptively select one of two configured preamble received target powers, p_{configured,first} and p_{configured},second, to use as the p_{configured} in Equation (1). The first power control setting may include a first RRC parameter that is used to determine the configured preamble received target power p_{configured},first. The second power control setting may include a second RRC parameter that is used to determine the configured preamble received target power p_{configured},second.

Given that ROs may be distributed in the SBFD region and the non-SBFD region, the terminal device 101 may select the earliest ROs available for each retransmission of the PRACH. On the other hand, radio link quality of the SBFD region and the non-SBFD region may be different, e.g., due to the existence of cross link interference in the SBFD region. Therefore, adaptive power control per retransmission attempt provides the technical advantage of providing flexibility in selecting an RO for the retransmission of the PRACH and reducing the latency in the retransmission of the PRACH.

The MAC entity 15 may select one of the p_{configured,first} and p_{configured,second} configured preamble received target powers after the RO preamble selection has been done. The MAC entity 15 may select one of the p_{configured,first} and p_{configured,second} preamble received target powers based on the selected RO.

The followings are examples of different criteria that the MAC entity 15 may use to select one of the p_{configured,first} and p_{configured,second} configured preamble received target powers. The MAC entity 15 may select one of the p_{configured,first} and p_{configured,second} configured preamble received target powers based on whether the selected RO is in the SBFD region. For example, the MAC entity 15 may select p_{configured,first} in a case that the selected RO is in the SBFD region and the MAC entity may select p_{configured,second} in a case that the selected RO is not in the SBFD region.

The MAC entity 15 may select one of the p_{configured,first} and p_{configured,second} configured preamble received target powers in a case that the RO is in both the SBFD region and the non-SBFD region. The MAC entity 15 may select one of the p_{configured,first} and p_{configured,second} preamble received target powers based on whether the selected RO is at least partially in the SBFD region.

The MAC entity 15 may select the p_{configured,first} in a case that the selected RO is at least partially in the SBFD region, and the MAC entity may select the p_{configured,second} in a case that the selected RO is not even partially in the SBFD region.

The MAC entity 15 may select one of the p_{configured,first} and p_{configured},second preamble received target powers based on whether the selected RO is fully in the SBFD region. For example, the MAC entity may select the p_{configured,first} in a case that the selected RO is fully in the SBFD region, and the MAC entity may select the p_{configured,second} in a case that the selected RO is not fully in the SBFD region.

The MAC entity 15 may select the p_{configured,first} in a case that the selected RO is both in the SBFD region and the non-SBFD region. The MAC entity may select the p_{configured,second} in a case that the selected RO is both in the SBFD region and the non-SBFD region.

An RRC parameter may be provided to the terminal device 101 which is used to determine which of the p_{configured,first} and p_{configured,second} is selected in a case that the selected RO is both in the SBFD region and the non-SBFD region.

In a case that the MAC entity 15 selected one of the parameters p_{configured,first} and p_{configured,second}, the MAC entity may calculate the P_{target} by using the selected parameter as the p_{configured} in Equation (1).

The MAC entity 15 may adaptively select one of the two values p_{step,first} and p_{step,second} to use as the power ramping step, pₛₜₑₚ, in Equation (1). The first power control setting may include a third RRC parameter used to determine the p_{step,first} The second power control setting may include a fourth RRC parameter used to determine the p_{step,second}. The MAC entity 15 may select one of the p_{step,first} and p_{step,second} power ramping steps after the RA preamble selection has been done.

The followings are examples of different criteria that the MAC entity 15 may use to select one of the p_{step,first} and p_{step,second} power ramping steps. The MAC entity may select one of the p_{step,first} and p_{step,second} power ramping steps based on the selected RO. The MAC entity may select one of the p_{step,first} and p_{step,second} power ramping steps based on whether the selected RO is in the SBFD region. For example, the MAC entity 15 may select p_{step,first} in a case that the selected RO is in the SBFD region, and the MAC entity 15 may select p_{step,second} in a case that the selected RO is not in the SBFD region.

The MAC entity 15 may select one of the p_{step,first} and p_{step,second} power ramping steps in a case that the RO is in both the SBFD region and the non-SBFD region. The MAC 15 entity may select one of the p_{step,first} and p_{step,second} power ramping steps based on whether the selected RO is at least partially in the SBFD region. For example, the MAC entity 15 may select the p_{step,first} in a case that the selected RO is at least partially in the SBFD region and the MAC entity may select the p_{step,second} in a case that the selected RO is not even partially in the SBFD region.

The MAC entity 15 may select one from p_{step,first} and p_{step,second} power ramping steps based on whether the selected RO is fully in the SBFD region. For example, the MAC entity 15 may select the p_{step,first} in a case that the selected RO is fully in the SBFD region, and the MAC entity may select the p_{step,second} in a case that the selected RO is not fully in the SBFD region.

The MAC entity 15 may select the p_{step,first} in a case that the selected RO is both in the SBFD region and the non-SBFD region. The MAC entity 15 may select the p_{step,second} in a case that the selected RO is both in the SBFD region and the non-SBFD region.

In some embodiments, an RRC parameter may be provided to the terminal device 101 which is used to determine which of the p_{step,first} and p_{step,second} power ramping steps is selected in a case that the selected RO is both in the SBFD region and the non-SBFD region.

In a case that the MAC entity 15 selected one of the parameters p_{step,first} and p_{step,second}, the MAC entity 15 may calculate the P_{target} by using the selected parameter as the pₛₜₑₚ in Equation (1).

The MAC entity 15, in some embodiments, may adaptively select one of the two power ramping counters, Cₚ₁ and Cₚ₂ to use as the Cₚ in Equation (1). The MAC entity may select one of the power ramping counters Cₚ₁ and Cₚ₂ after the RA preamble selection has been done.

The MAC 15 entity may select one of the Cₚ₁ and Cₚ₂ power ramping counters based on the selected RO. The MAC entity 15 may use different criteria for selecting one of the Cₚ₁ and Cₚ₂ power ramping counters based on the selected RO. For example, the MAC entity 15 may select one of the Cₚ₁ and Cₚ₂ power ramping counters based on whether the selected RO is in the SBFD region (e.g., one of the 801-804 regions shown in FIG. 8).

The followings are examples of different criteria that the MAC entity 15 may use to select one of the Cₚ₁ and Cₚ₂ power ramping counters. The MAC entity 15, in some embodiments, may select the Cₚ₁ in a case that the selected RO is in the SBFD region, and the MAC entity 15 may select the Cₚ₂ in a case that the selected RO is not in the SBFD region. The MAC entity 15 may select either one of the Cₚ₁ and Cₚ₂ power ramping counters in a case that the RO is in both the SBFD region and the non-SBFD region.

The MAC entity 15, in some embodiments, may select one of the Cₚ₁ and Cₚ₂ power ramping counters based on whether the selected RO is at least partially in the SBFD region. The MAC entity 15, in some embodiments, may select Cₚ₁ in a case that the selected RO is at least partially in the SBFD region, and the MAC entity 15 may select Cₚ₂ in a case that the selected RO is not even partially in the SBFD region.

The MAC entity 15, in some embodiments, may select one of the Cₚ₁ and Cₚ₂ power ramping counters based on whether the selected RO is fully in the SBFD region. For example, the MAC entity 15, in some embodiments, may select the Cₚ₁ in a case that the selected RO is fully in the SBFD region, and the MAC entity 15 may select the Cₚ₂ in a case that the selected RO is not fully in the SBFD region.

The MAC entity 15, in some embodiments, may select Cₚ₁ in a case that the selected RO is both in the SBFD region and the non-SBFD region. The MAC entity 15, in some embodiments, may select the Cₚ₂ in a case that the selected RO is both in the SBFD region and the non-SBFD region. The BS 103 may provide an RRC parameter to the terminal device 101 to determine which one of the Cₚ₁ and Cₚ₂ power ramping counters may be selected in a case that the selected RO is both in the SBFD region and the non-SBFD region.

In a case that the MAC entity 15 selects one of the Cₚ₁ and Cₚ₂ power ramping counters, the MAC entity 15 may calculate the P_{target} by using the selected counter as the Cₚ in Equation (1). The process 900 may use the initial value of the selected power ramping counter for the first transmission of the RA preamble. For example, if the Cₚ₁ and Cₚ₂ power ramping counters were initialized to 1 in block 905, the process 900 may use the value of 1 for the Cₚ in Equation (1). As described below with reference to blocks 935, 950, and 955, if the RA preamble transmission fails, the process 900 may proceed back to block 915 to select another RO and retransmit the RA preamble. In a case of retransmission of the RA preamble, the process 900 may increment the power ramping counter that is selected based on the selected RO before using the Equation (1) to calculate the parameter P_{target}. For example, the MAC entity 15 may increment the selected power ramping counter, if the lower layer does not issue suspension of power ramping counter. The wireless transmission and reception unit 10 may issue the suspension of power ramping counter if the spatial filter for the PRACH changes.

The process 900 may calculate (at block 925) the Random Access Radio Network Temporary Identifier (RA-RNTI). The RA-RNTI is a bit sequence used to mask the cyclic redundancy check (CRC) bits that are appended to the DCI. The RA-RNTI works as an identifier indicating for which DCI the UE should decode.

The process 900 may transmit (at block 930) the RA preamble at the calculated RA preamble transmission power. For example, according to the instruction from the MAC entity 15, the wireless transmission and reception unit 10 may transmit the RA preamble at the transmission power that is calculated using Equation (2).

The process 900 may make a determination (at block 935) as to whether a Random-Access Response (RAR) with the transmitted preamble index has been received before the end of the RAR window. For example, the MAC entity 15 may monitor the RAR which indicates the RA preamble index selected in block 915, described above. In a case that, within the RAR window (e.g., a defined time window), the MAC entity 15 does not detect a RAR which indicates the selected RA preamble index, the MAC entity 15 may consider RAR reception as not successful. In this case, the process 900 may proceed to block 950, which is described below.

In a case that the MAC entity 15 detects a RAR which indicates the selected RA preamble index, the MAC entity 15 may consider the RAR reception as successful. In this case, the process 900 may transmit (at block 940) a message 3 (MSG3) PUSCH transmission. For example, the MAC entity 15 may instruct the wireless transmission and reception unit 10 to transmit a message PUSCH transmission.

The process 900 may make a determination (at block 945) as to whether the contention resolution is successful. For example, the contention resolution may be achieved by the reception of DL assignments, UL grants, or a PDSCH including a contention resolution identifier. In a case where the contention resolution is successful, the process 900 may determine that random-access has been successfully completed and the process 900 may end. In a case where the contention resolution is not successful, the process 900 may proceed to block 950.

At block 950, the process 900 may determine whether the transmission counter C_{TX} is equal to the configured maximum transmission number. The configured maximum transmission number may be provided by one or more RRC parameters by the BS. In a case that the transmission counter C_{TX} is equal to the configured maximum transmission number, the process 900 may report (at block 960) an RA problem. For example, the MAC entity 15 may report “random-access problem” to the higher layers. The process 900 may then end.

In a case that the transmission counter C_{TX} is not equal to the configured maximum transmission number, the process 900 may increment (at block 955) the transmission counter C_{TX}. The process 900 may then proceed to block 915, which was described above.

In the example CBRA procedures described in FIG. 9, once the RA configuration is selected in block 910, the process 900 may repeat the RA preamble transmissions using the same RA configuration until the RA is successfully completed (as described above with reference to block 945) or the RA problem is reported to the higher layers (as described above with reference to block 960.

The specific operations of the process 900 may not be performed in the exact order shown and described. Furthermore, the specific operations described with reference to FIG. 9 may not be performed in one continuous series of operations in some embodiments, and different specific operations may be performed in different embodiments. In addition, one or more steps of the process 900 may be skipped in different embodiments.

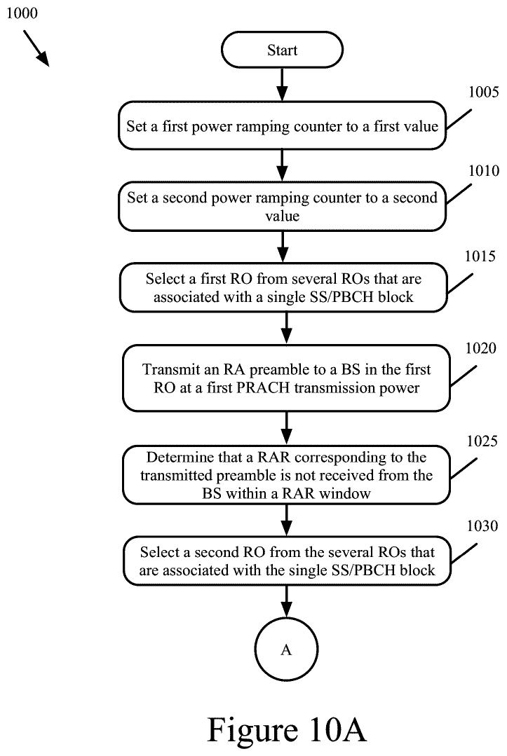

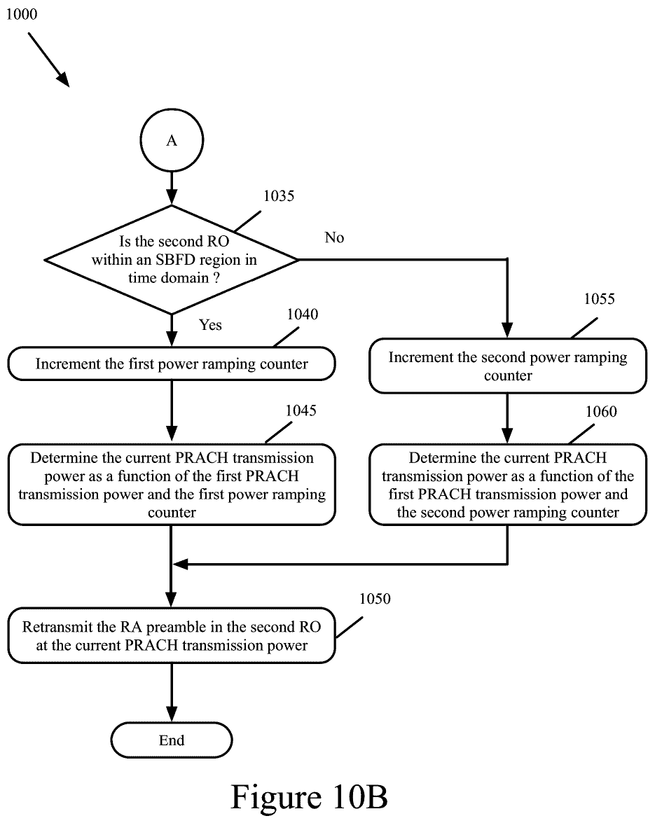

FIGS. 10A-10B illustrate a flowchart of an example method/process 1000 performed by a terminal device to determine the PRACH transmission power using two power ramping counters, according to an example implementation of the present disclosure. The process 1000 may be performed by at least one processor of the terminal device 101, shown in FIG. 6. For example, the processor of the terminal device 101 may perform the process 1000 in the MAC entity 15 and the wireless transmission and reception unit 10.

The process 1000 may set (at block 1005) a first power ramping counter to a first value. For example, the MAC entity 15 may set the power ramping counter Cₚ₁ to 1 as a part of the initialization of the RA procedure parameters. The process 1000 may set (at block 1010) a second power ramping counter to a second value. For example, the MAC entity 15 may set the power ramping counter Cₚ₂ to 1 as a part of the initialization of the RA procedure parameters.

The process 1000 may select (at block 1015) a first RO from several ROs that are associated with a single SS/PBCH block. For example, the MAC entity 15 may select an RO that is associated with the single SS/PBCH block in one of the SBFD regions 801-804 or one of the non-SBFD regions 821-824 shown in FIG. 8.

The process 1000 may transmit (at block 1020) an RA preamble to a BS in the first RO at a first PRACH transmission power. The first transmission power may, for example, be the P_{PRACH} shown in the Equation (2). The value of the parameter P_{target} in the Equation (2) may be calculated from the Equation (1) by setting the value of Cₚ to 1, resulting in the value of Cₚ−1 to be 0. As described below, in case of a retransmission of the RA preamble, the selected power ramping counter may be incremented in order to calculate a current power transmission power for the RA preamble retransmission. The first PRACH transmission power may be a function of a value associated with a preamble format used to transmit the PRACH and an initial power value received from the BS as an RRC parameter in an RRC message.

The process 1000 may determine (at block 1025) that a RAR corresponding to the transmitted preamble is not received from the BS within a RAR window. The process 1000 may select (at block 1030) a second RO from the several ROs that are associated with the single SS/PBCH block.

The process 1000 may make a determination (at block 1035) as to whether the second RO is within an SBFD region in time domain. In a case that the second RO is not within an SBFD region in time domain, the process 1000 may proceed to block 1055, which is described below. In a case that the second RO is within an SBFD region in time domain, the process 1000 may increment (at block 1040) the first power ramping counter. For example, the MAC entity 15 may increment the power ramping counter Cₚ₁.

The process 1000 may determine (at block 1045) the current PRACH transmission power as a function of the first PRACH transmission power and the first power ramping counter. The current PRACH transmission power may further be a function of an RSRP received, from the BS, as an RRC parameter. The current PRACH transmission power may further be a function of a power ramping step received, from the BS, as an RRC parameter in an RRC message. The process 1000 may retransmit (at bloc 1050) the RA preamble in the second RO at the current PRACH transmission power. The process 1000 may then end.

In a case that the second RO is not within an SBFD region in time domain, the process 1000 may increment (at block 1055) the second power ramping counter. For example, the MAC entity 15 may increment the power ramping counter Cₚ₂. The process 1000 may determine (at block 1060) the current PRACH transmission power as a function of the first PRACH transmission power and the second power ramping counter. The process 1000 may then proceed to block 1050, which was described above.

In a case that a RAR corresponding to the retransmitted RA preamble is received from the BS within the RAR window after the retransmission of the RA preamble in the second RO, the process 1000 may transmit a MSG3 of the RA procedure in response to determining that the RAR corresponding to the transmitted preamble is received from the BS.

In a case that the process 1000 is performing the RA procedure in a CBRA mode, the process 1000 may perform contention resolution by receiving, from the BS, a DL assignment, a UL grant, or a PDSCH that includes a contention resolution identifier.

In a case that a RAR corresponding to the retransmitted RA preamble is not received from the BS within the RAR window after the retransmission of the RA preamble within the second RO at the current PRACH transmission power, the process 1000 may iteratively select another RO from the several ROs, update the current PRACH transmission power based on whether the selected RO is within the SBFD region or outside the SBFD region, and retransmit the RA preamble, in the selected RO, at the updated current transmission power, for a number of times.

The process 1000 may send an RA problem message indicating that the RA procedure has not been performed successfully in a case that no RAR corresponding to a transmitted RA preamble is received from the BS and the number of RA preamble transmissions reaches a maximum number of allowed transmissions. The process 1000 may receive the maximum number of allowed transmissions from the BS as an RRC parameter in an RRC message.

The process 1000 may transmit a MSG3 of the RA procedure in case that a RAR corresponding to a transmitted RA preamble is received from the BS after an RA preamble retransmission.

The process 1000 may stop incrementing the first power ramping counter in a case that the first power ramping counter reaches a corresponding maximum value. The process 1000 may stop incrementing the second power ramping counter in a case that the second power ramping counter reaches a corresponding maximum value.

During the iterative retransmission of the RA preamble, the process 1000 may receive, from a lower layer, a notification requesting the suspension of incrementing the first and second power ramping counters. In response to receiving the notification requesting the suspension, the process 1000 may stop incrementing the first and second power ramping counters.

The process 1000 may select an RA preamble index. In some embodiments, transmitting the RA preamble in the first RO or retransmitting the RA preamble in the second ROs may include transmitting an RA preamble associated with the RA preamble index, and determining that the RAR corresponding to the transmitted preamble is not received from the BS may include determining that a RAR corresponding to the RA preamble index is not received from the BS.

The specific operations of the process 1000 may not be performed in the exact order shown and described. Furthermore, the specific operations described with reference to FIG. 10 may not be performed in one continuous series of operations in some embodiments, and different specific operations may be performed in different embodiments. In addition, one or more steps of the process 1000 may be skipped in different embodiments.

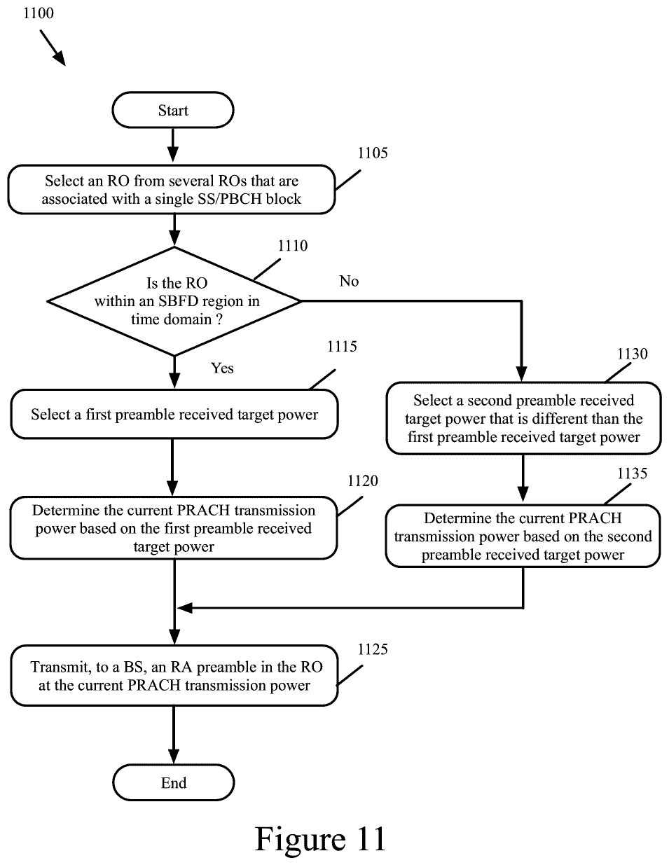

FIG. 11 is a flowchart illustrating an example method/process 1100 performed by a terminal device to determine the PRACH transmission power using two preamble received target powers, according to an example implementation of the present disclosure. The process 1100 may be performed by at least one processor of the terminal device 101, shown in FIG. 6. For example, the processor of the terminal device 101 may perform the process 1100 in the MAC entity 15 and the wireless transmission and reception unit 10.

The process 1100 may select (at block 1105) an RO from several ROs that are associated with a single SS/PBCH block. For example, the MAC entity 15 may select an RO that is associated with the single SS/PBCH block in one of the SBFD regions 801-804 or one of the non-SBFD regions 821-824 shown in FIG. 8.

The process 1100 may make a determination (at block 1110) as to whether the RO is within an SBFD region in time domain. In a case that the second RO is not within an SBFD region in time domain, the process 1100 may proceed to block 1130, which is described below.

In a case that the second RO is within an SBFD region in time domain, the process 1100 may select (at block 1115) a first preamble received target power. For example, the process may select the p_{configured,first} configured preamble received target power to use as the p_{configured}.

The process 1100 may determine (at block 1120) the current PRACH transmission power based on the first preamble received target power. For example, the current PRACH transmission power may be the P_{PRACH} shown in the Equation (2). The value of the parameter P_{target} in the Equation (2) may be calculated from the Equation (1) by setting the value of p_{configured},to p_{configured,first}. The process 1100 may transmit (at block 1125), to a BS, an RA preamble in the RO at the current PRACH transmission power. The process 1100 may then end.

In a case that the second RO is not within an SBFD region in time domain, the process 1100 may select (at block 1130) a second preamble received target power. For example, the process may select the p_{configured,second} configured preamble received target power to use as the p_{configured}.

The process 1100 may determine (at block 1135) the current PRACH transmission power based on the second preamble received target power. For example, the current PRACH transmission power may be the P_{PRACH} shown in the Equation (2). The value of the parameter P_{target} in the Equation (2) may be calculated from the Equation (1) by setting the value of p_{configured},to p_{configured,second}. The process 1100 may then proceed to block 1125, which was described above.

In a case that the RO is partially with the SBFD region, the process 1100 may select one of the first or second preamble received target powers and may determine the current PRACH transmission power based on the selected preamble received target power. In some embodiments, the first or second preamble received target powers may be selected based on an RRC parameter received from the BS.

In a case that the RO is partially within the SBFD region in the time domain, the process 1100 may select the first preamble received target power and may determine the current PRACH transmission power based on the first preamble received target power. In a case that the RO is partially outside the SBFD region in the time domain, the process 1100 may select the second preamble received target power and may determine the current PRACH transmission power based on the second preamble received target power. The process 1100 may receive the first and second preamble received target powers from the BS as RRC parameters.

The process 1100, in some embodiments, may determine that an RAR corresponding to the transmitted preamble is not received from the BS within a RAR window. In response, the process 1100 may select a second RO from the several ROs associated with the single SS/PBCH block. The process 1100 may then determine whether the second RO is within an SBFD region in the time domain. In a case that the second RO is within the SBFD region in the time domain, the process 1100 may select a first preamble power ramping step. For example, the process 1100 may select the p_{step,first}. The process 1100 may then update the current PRACH transmission power based on the first preamble power ramping step. For example, the process 1100 may update the current PRACH transmission power by using the p_{step,first} as the power ramping step, pₛₜₑₚ, in Equation (1).

In a case that the second RO is not within the SBFD region in the time domain, the process 1100 may select a second preamble power ramping step. For example, the process 1100 may select the p_{step,second}. The process 1100 may then update the current PRACH transmission power based on the second preamble power ramping step. For example, the process 1100 may update the current PRACH transmission power by using the p_{step,second} as the power ramping step, pₛₜₑₚ, in Equation (1). The process 1100 may retransmit the RA preamble in the second RO at the current PRACH transmission power.

In a case that the second RO is partially within the SBFD region in the time domain, the process 1100 may select one of the first or second preamble power ramping steps and may update the current PRACH transmission power based on the selected preamble power ramping step. In some embodiments, selecting one of the first or second preamble power ramping steps may be based on RRC parameters that are received from the BS.

In a case that the second RO is partially outside the SBFD region in the time domain, the process 1100 may select the second preamble power ramping step and may update the current PRACH transmission power based on the second preamble power ramping step.

The process 1100, in some embodiments, may set a first power ramping counter. For example, the MAC entity 15 may set the power ramping counter Cₚ₁ to 1 as a part of the initialization of the RA procedure parameters. The process 1000 may set a second power ramping counter to a second value. For example, the MAC entity 15 may set the power ramping counter Cₚ₂ to 1 as a part of the initialization of the RA procedure parameters.

In a case that the second RO is within the SBFD region in the time domain, the process 1100 may increment the first power ramping counter and may update the current PRACH transmission power further based on the first power ramping counter. In a case that the second RO is not within the SBFD region in the time domain, the process 1100 may increment the second power ramping counter and may determine the current PRACH transmission power further based on the second power ramping counter.

The process 1100, in some embodiments, may determine that a RAR corresponding to the retransmitted RA preamble is not received from the BS within the RAR window after the retransmission of the RA preamble in the second RO at the current PRACH transmission power. The process 1100 may iteratively select another RO from the plurality of ROs, update the current PRACH transmission power based on whether the selected RO is within the SBFD region or outside the SBFD region in the time domain, and retransmit the RA preamble, in the selected RO, at the updated current transmission power, for a number of times.

The specific operations of the process 1100 may not be performed in the exact order shown and described. Furthermore, the specific operations described with reference to FIG. 11 may not be performed in one continuous series of operations in some embodiments, and different specific operations may be performed in different embodiments. In addition, one or more steps of the process 1100 may be skipped in different embodiments.

The various foregoing example embodiments and modes may be utilized in conjunction with one another, e.g., in combination with one another.

Each of a program running on the base station device 103 and the terminal device 101 according to an aspect of the present invention may be a program that controls a Central Processing Unit (CPU) and the like, such that the program causes a computer to operate in such a manner as to realize the functions of the above-described embodiment according to the present invention. The information handled in these devices is transitorily stored in a Random-Access-Memory (RAM) while being processed. Thereafter, the information is stored in various types of Read-Only-Memory (ROM) such as a Flash ROM and a Hard-Disk-Drive (HDD), and when necessary, is read by the CPU to be modified or rewritten.

Note that the terminal device 101 and the base station device 103 according to the above-described embodiment may be partially achieved by a computer. In this case, this configuration may be realized by recording a program for realizing such control functions on a computer-readable recording medium and causing a computer system to read the program recorded on the recording medium for execution.

Note that it is assumed that the “computer system” mentioned here refers to a computer system built into the terminal device 101 or the base station device 103, and the computer system includes an OS and hardware components such as a peripheral device. Furthermore, the “computer-readable recording medium” refers to a portable medium such as a flexible disk, a magneto-optical disk, a ROM, a CD-ROM, and the like, and a storage device built into the computer system such as a hard disk.

Moreover, the “computer-readable recording medium” may include a medium that dynamically retains a program for a short period of time, such as a communication line that is used to transmit the program over a network such as the Internet or over a communication line such as a telephone line, and may also include a medium that retains a program for a fixed period of time, such as a volatile memory within the computer system for functioning as a server or a client in such a case. Furthermore, the program may be configured to realize some of the functions described above, and also may be configured to be capable of realizing the functions described above in combination with a program already recorded in the computer system.

Furthermore, the base station device 103 according to the above-described embodiment may be achieved as an aggregation (a device group) including multiple devices. Each of the devices configuring such a device group may include some or all of the functions or the functional blocks of the base station device 103 according to the above-described embodiment. The device group may include each general function or each functional block of the base station device 103. Furthermore, the terminal device 101 according to the above-described embodiment can also communicate with the base station device as the aggregation.

Furthermore, the base station device 103 according to the above-described embodiment may serve as an Evolved Universal Terrestrial Radio Access Network (E-UTRAN) and/or NG-RAN (Next Gen RAN, NR-RAN). Furthermore, the base station device 103 according to the above-described embodiment may have some or all of the functions of a node higher than an eNodeB or the gNB.

Furthermore, some or all portions of each of the terminal device 101 and the base station device 103 according to the above-described embodiment may be typically achieved as an LSI which is an integrated circuit or may be achieved as a chip set. The functional blocks of each of the terminal device 101 and the base station device 103 may be individually achieved as a chip, or some or all of the functional blocks may be integrated into a chip. Furthermore, a circuit integration technique is not limited to the LSI, and may be realized with a dedicated circuit or a general-purpose processor. Furthermore, in a case that with advances in semiconductor technology, a circuit integration technology with which an LSI is replaced appears, it is also possible to use an integrated circuit based on the technology.

Furthermore, according to the above-described embodiment, the terminal device 101 has been described as an example of a communication device, but the present invention is not limited to such a terminal device, and is applicable to a terminal device or a communication device of a fixed-type or a stationary-type electronic device installed indoors or outdoors, for example, such as an Audio-Video (AV) device, a kitchen device, a cleaning or washing machine, an air-conditioning device, office equipment, a vending machine, and other household devices.

The embodiments of the present invention have been described in detail above referring to the drawings, but the specific configuration is not limited to the embodiments and includes, for example, an amendment to a design that falls within the scope that does not depart from the gist of the present invention. Furthermore, various modifications are possible within the scope of one aspect of the present invention defined by claims, and embodiments that are made by suitably combining technical means disclosed according to the different embodiments are also included in the technical scope of the present invention. Furthermore, a configuration in which constituent elements, described in the respective embodiments and having mutually the same effects, are substituted for one another is also included in the technical scope of the present invention.

What is claimed is:

1. A user equipment (UE), comprising:
one or more non-transitory computer-readable media storing one or more computer-executable instructions for controlling physical random access channel (PRACH) transmission power; and
at least one processor coupled to the one or more non-transitory computer-readable media, and configured to execute the one or more computer-executable instructions to cause the UE to:
select a random access (RA) channel occasion (RO) from a plurality of ROs associated with a single synchronization signal/physical broadcast channel (SS/PBCH) block;
determine whether the RO is within a subband full duplex (SBFD) region in time domain;
in a case that the RO is fully within the SBFD region in the time domain:
select a first preamble received target power; and
determine a current PRACH transmission power based on the first preamble received target power;
in a case that the RO is fully outside the SBFD region in the time domain:
select a second preamble received target power, wherein the second preamble received target power is different from the first preamble received target power; and
determine the current PRACH transmission power based on the second preamble received target power; and
transmit, to a base station (BS), an RA preamble in the RO at the current PRACH transmission power.

2. The UE of claim 1, wherein the at least one processor is further configured to execute the one or more computer-executable instructions to cause the UE to:
in a case that the RO is partially within the SBFD region in the time domain:
select one of the first or second preamble received target powers; and
determine the current PRACH transmission power based on the selected preamble received target power.

3. The UE of claim 2, wherein selecting one of the first or second preamble received target powers comprises:
selecting one of the first or second preamble received target powers based on a radio resource control (RRC) parameter received from the BS.

4. The UE of claim 1, wherein the at least one processor is further configured to execute the one or more computer-executable instructions to cause the UE to:
in a case that the RO is partially within the SBFD region in the time domain:
select the first preamble received target power; and
determine the current PRACH transmission power based on the first preamble received target power.

5. The UE of claim 1, wherein the at least one processor is further configured to execute the one or more computer-executable instructions to cause the UE to:
in a case that the RO is partially outside the SBFD region in the time domain:
select the second preamble received target power; and
determine the current PRACH transmission power based on the second preamble received target power.

6. The UE of claim 1, wherein the at least one processor is further configured to execute the one or more computer-executable instructions to cause the UE to:
receive the first and second preamble received target powers from the BS as radio resource control (RRC) parameters.

7. The UE of claim 1, wherein the UE further comprises:
a medium access control (MAC) layer unit; and
a physical layer unit;
wherein:
the MAC layer unit is configured to:
select the RO from the plurality of ROs associated with the single SS/PBCH block,
determine whether the RO is within the SBFD region in the time domain, and
select one of the first or second preamble received target powers, and the physical layer unit is configured to:
transmit the RA preamble in the RO at the current PRACH transmission power.

8. The UE of claim 1, wherein the RO is a first RO, wherein the at least one processor is further configured to execute the one or more computer-executable instructions to cause the UE to:
determine that an RA response (RAR) corresponding to the transmitted preamble is not received from the BS within a RAR window;
select a second RO from the plurality of ROs associated with the single SS/PBCH block;
determine whether the second RO is within an SBFD region in the time domain;
in a case that the second RO is within the SBFD region in the time domain:
select a first power ramping step; and
update the current PRACH transmission power based on the first power ramping step;
in a case that the second RO is not within the SBFD region in the time domain:
select a second power ramping step; and
update the current PRACH transmission power based on the second power ramping step; and
retransmit the RA preamble in the second RO at the current PRACH transmission power.

9. The UE of claim 8, wherein the at least one processor is further configured to execute the one or more computer-executable instructions to cause the UE to:
in a case that the second RO is partially within the SBFD region in the time domain:
select one of the first or second power ramping steps; and
update the current PRACH transmission power based on the selected power ramping step.

10. The UE of claim 9, wherein selecting one of the first or second power ramping steps comprises:
selecting one of the first or second power ramping steps based on radio resource control (RRC) parameters received from the BS.

11. The UE of claim 8, wherein the at least one processor is further configured to execute the one or more computer-executable instructions to cause the UE to:
in a case that the second RO is partially within the SBFD region in the time domain:
select the first power ramping step; and
update the current PRACH transmission power based on the first power ramping step.

12. The UE of claim 8, wherein the at least one processor is further configured to execute the one or more computer-executable instructions to cause the UE to:
in a case that the second RO is partially outside the SBFD region in the time domain:
select the second power ramping step; and
update the current PRACH transmission power based on the second power ramping step.

13. The UE of claim 8, wherein the at least one processor is further configured to execute the one or more computer-executable instructions to cause the UE to:
set a first power ramping counter;
set a second power ramping counter;
in a case that the second RO is within the SBFD region in the time domain:
increment the first power ramping counter; and
update the current PRACH transmission power further based on the first power ramping counter;
in a case that the second RO is not within the SBFD region in the time domain:
increment the second power ramping counter; and
determine the current PRACH transmission power further based on the second power ramping counter.

14. The UE of claim 8, wherein the at least one processor is further configured to execute the one or more computer-executable instructions to cause the UE to:
determine that a RAR corresponding to the retransmitted RA preamble is not received from the BS within the RAR window after the retransmission of the RA preamble in the second RO at the current PRACH transmission power; and
iteratively select another RO from the plurality of ROs, update the current PRACH transmission power based on whether the selected RO is within the SBFD region or outside the SBFD region in the time domain, and retransmit the RA preamble, in the selected RO, at the updated current transmission power, for a number of times.

15. A method of controlling physical random access channel (PRACH) transmission power, the method comprising:
selecting a random access (RA) channel occasion (RO) from a plurality of ROs associated with a single synchronization signal/physical broadcast channel (SS/PBCH) block;
determining whether the RO is within a subband full duplex (SBFD) region in time domain;
in a case that the RO is fully within the SBFD region in the time domain:
selecting a first preamble received target power; and
determining a current PRACH transmission power based on the first preamble received target power;
in a case that the RO is not fully within the SBFD region:
selecting a second preamble received target power, wherein the second preamble received target power is different from the first preamble received target power; and
determining the current PRACH transmission power based on the second preamble received target power; and
transmitting, to a base station (BS), an RA preamble in the RO at the current PRACH transmission power.
